(19) United States
(12) Patent Application Publication
(10) Pub. No.: US 2010/0014063 A1
(43) Pub. Date: Jan. 21, 2010

(54) IMAGE EXPOSURE APPARATUS

(75) Inventors: Katsuto Sumi, Kanagawa-ken (JP); Shuichi Ishii, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 11/916,048

(22) PCT Filed: May 31, 2003
(86) PCT No.: PCT/JP2006/311368

§ 371 Date: Nov. 30, 2007

(30) Foreign Application Priority Data
May 31, 2005 (JP) 2005-159707
May 31, 2005 (JP) 2005-159708
May 31, 2005 (JP) 2005-159709

(51) Int. Cl. G03B 27/54; G02B 26/00

(52) U.S. Cl. 355/67; 359/290

(57) ABSTRACT

An image exposure apparatus includes: a spatial light modulating element, constituted by a plurality of pixel portions for individually modulating light irradiated thereon; a light source, for irradiating light on the spatial light modulating element; and a focusing optical system. The focusing optical system includes: an optical system, for focusing an image borne by each of the pixel portions; and a micro lens array, in which a plurality of micro lenses into which the light beams modulated by the pixel portions enter individually are provided in an array. The micro lens array is provided in the vicinity of a focusing position of the pixel portions by the focusing optical system. Each micro lens of the micro lens array has different powers in two directions within a plane perpendicular to the optical axis, to correct aberrations caused by anisotropic distortions in the pixel portions.

### TECHNICAL FIELD

The present invention relates to an image exposure apparatus. Particularly, the present invention relates to an image exposure apparatus that causes light, which has been modulated by a spatial light modulating element, to pass through a focusing optical system, to focus an image represented by the light onto a photosensitive material, thereby exposing the photosensitive material.

### BACKGROUND ART

There are known image exposure apparatuses that cause light, which has been modulated by a spatial light modulating element, to pass through a focusing optical system, to focus an image represented by the light onto a photosensitive material, thereby exposing the photosensitive material. This type of image exposure apparatus basically comprises: a spatial light modulating element, constituted by a plurality of pixel portions for individually modulating light irradiated thereon according to control signals; a light source for irradiating light onto the spatial light modulating element; and a focusing optical system, for focusing an image represented by the light modulated by the spatial light modulating element onto a photosensitive material. Note that Japanese Unexamined Patent Publication No. 2004-001244 and A. Ishikawa, “Shortening Development and Adaptation to Mass Production byMaskless Exposure”, Electronics Mounting Technology, Vol. 18, No. 6, pp. 74-79, Gicho Publishing & Advertising Co., Ltd., 2002 disclose examples of image exposure apparatuses having the basic construction described above.

In this type of image exposure apparatus, LCD's (Liquid Crystal Display elements), DMD's (Digital Micro mirror Devices), and the like are favorably employed as the spatial light modulating element. Note that a DMD is a mirror device constituted by a great number of micro mirrors that change the angle of their reflective surfaces according to control signals, arranged two dimensionally on a semiconductor substrate such as a silicon substrate. In the DMD's, the micro mirrors function as reflective pixel portions of the spatial light modulating element.

It is often required that an image to be projected onto the photosensitive material be magnified, in the aforementioned image exposure apparatuses. In these cases, a magnifying focusing optical system is employed as the focusing optical system. If the light which has been modulated by the spatial light modulating element is simply caused to enter the magnifying focusing optical system, the condensing of each pixel portion of the spatial light modulating element becomes magnified. This causes the pixel size of the projected image to become greater, and the image resolution decreases.

Therefore, a configuration is being considered, wherein: a first focusing optical system is provided within the optical path of the light, which has been modulated by the spatial light modulating element; a micro lens array, in which micro lenses that correspond to each pixel portion of the spatial light modulating element are arranged in an array, is provided at the focusing surface of the focusing optical system; and a second focusing optical system, for focusing the image represented by the light modulated by the spatial light modulating element onto a photosensitive material or a screen, is provided within the optical path of the light which has passed through the micro lens array. By adopting this configuration, the first and second optical systems enable magnified projection of the image. In this configuration, the size of the image projected onto the photosensitive material or the screen is magnified. Meanwhile, the light that propagates from each pixel portion of the spatial light modulating element is condensed by each micro lens of the micro lens array. Therefore, the pixel size (spot size) within the projected image is maintained to be small, thereby maintaining the sharpness of the image.

Note that Japanese Unexamined Patent Publication No. 2001-305663 discloses an example of an image exposure apparatus that employs a DMD as the spatial light modulating element, combined with a micro lens array.

Japanese Unexamined Patent Publication No. 2004-122470 discloses the same type of image exposure apparatus, comprising: a micro lens array; and an aperture array (apertured plate) having apertures (openings) corresponding to each of the micro lenses in the micro lens array, provided behind the micro lens array. By adopting this configuration, only light which has passed through the corresponding micro lens passes through the apertures. In this configuration, each of the apertures of the aperture plate prevent light from micro lenses adjacent to the micro lens that corresponds to the aperture from entering thereinto. Therefore, the entry of stray light into adjacent pixels can be suppressed. In addition, there are cases that slight amounts of light enter an exposure surface, even when the pixels (micro mirrors) of the DMD are turned OFF such that light does not irradiate the exposure surface. However, by adopting this configuration, the amount of light that enters the exposure surface when the DMD pixels are in an OFF state can be reduced.

However, in image exposure apparatuses such as those described above, astigmatic differences are generated among light beams, which are condensed by the micro lenses of the micro lens array after being modulated by the pixel portions of the spatial light modulating element, causing the light beams to become oval in cross section. As a result, small pixel sizes cannot be maintained in projected images, and the sharpness of the projected images are deteriorated. The astigmatic differences are mainly caused by distortions in the surfaces of the pixel portions of the spatial light modulating element. In the case that a DMD is employed as the spatial light modulating element, the main cause of the distortions is the distortions of the reflective surfaces of the pixel portions of the DMD.

Particularly in the case that anisotropic distortions, in which the reflective surfaces of the pixel portions are rotationally asymmetrical with respect to the optical axis, are present, the optical system generates astigmatic aberrations. In this case, the light beams which are condensed by the micro lenses via the reflective surfaces of the pixel portions have different beam waist positions (the position in the direction of the optical axis at which the beam diameter is minimal), depending on the direction within planes perpendicular to the optical axes thereof.

Specifically, if the directions within a plane perpendicular to an optical axis are designated as an X direction and a Y direction, the beam diameter in the Y direction is not minimal at the beam waist position in the X direction, at which the beam diameter in the X direction is minimal. That is, the cross sectional shape of the light beam becomes an oval. Similarly, the beam diameter in the X-direction is not minimal at the beam waist position in the Y direction, at which the beam diameter in the Y direction is minimal, and the cross sectional shape of the light beam becomes an oval. Because an image is focused onto the photosensitive material two dimensionally, if these light beams are employed as they are to form the image, the sharpness thereof deteriorates.

The above phenomenon is conspicuous when the reflective surfaces of the pixel portions have powers of different signs in two different directions within a plane perpendicular to an optical axis, which becomes a problem during obtainment of highly detailed images.

A reflective surface, which has been designed to be of a predetermined curved surface and in which an unintended distortion occurs, is an example of a reflective surface of a pixel portion which is rotationally asymmetrical. This type of reflective surface commonly has different powers of the same sign. In this case as well, the aforementioned astigmatic aberration occurs, and deterioration of image sharpness is unavoidable.

Meanwhile, the conventional image exposure apparatus comprises: the spatial light modulating element that has reflective pixel portions such as the aforementioned DMD; the micro lens array; and the focusing optical system. This conventional image exposure apparatus is configured such that the focusing optical system focuses the images of the pixel portions (micro mirrors), and such that each micro lens of the micro lens array is positioned at the focusing position of a pixel portion.

However, the relative positional relationship between the spatial light modulating element and the micro lens array must be maintained in a strict predetermined relationship. Otherwise, problems, such as decreases in light utilization efficiency and extinction ratios, become more likely to occur. Hereinafter, this point will be described in detail.

The areas denoted by reference numeral 100 in FIG. 48A represents a pixel portion of the spatial light modulating element, that is, the image of a micro mirror of a DMD, for example. Reference numeral 101 in FIG. 48B denotes a micro lens array 101, in which micro lenses 102 are provided. When the micro mirror image 100 is focused onto the micro lens portion 102 of the micro lens array 101, if the micro mirror image 100 is focused to be larger than the size of the micro lens 102, the state illustrated in FIG. 49A occurs. If the spatial light modulating element and the micro lens array are shifted in a direction that intersects with the optical axes of the light beams, the state illustrated in FIG. 49B occurs, and a great amount of eclipse is generated. In these cases, the light, which has been reflected at the peripheral portions of the micro mirrors, is not utilized for image exposure, and the light utilization efficiency becomes low.

In many cases, masks for shielding unnecessary light are provided at the exteriors of the peripheral edges of the micro lenses 102, either integrally therewith or separately. In the case that a mask is provided, the eclipsed light is shielded thereby. Even if a mask is not provided, the eclipsed light misses the apertures of the micro lenses 102 and is not condensed thereby, and therefore is not utilized for the intended purpose.

Further, if the degree of shifting such as that illustrated in FIG. 49B becomes great, a portion of a micro mirror image 100 intended to be focused on a micro lens 102A may be focused onto an adjacent micro lens 102B. If light which is to pass through the micro lens 102B is to be completely shut out, the extinction ratio decreases, because light which is intended to pass through the micro lens 102A enters thereinto.

### DISCLOSURE OF THE INVENTION

The present invention has been developed in view of the foregoing circumstances. It is a first object of the present invention to provide an image exposure apparatus that enables obtainment of highly detailed images, even in the case that anisotropic distortions are present within pixel portions of a spatial light modulating element.

It is a second object of the present invention to provide an image exposure apparatus that enables obtainment of highly detailed images, even in the case that pixel portions of a spatial light modulating element have powers of different signs in two directions within a plane perpendicular to optical axes.

It is a third object of the present invention to provide an image exposure apparatus that enables obtainment of highly detailed images, even in the case that pixel portions of a spatial light modulating element have different powers of the same sign in two directions within a plane perpendicular to optical axes, while maintaining a high light utilization efficiency and a high extinction ratio.

A first image exposure apparatus according to the present invention comprises:

a spatial light modulating element, in which a plurality of pixel portions for individually modulating light irradiated thereon according to control signals are provided;

a light source, for irradiating light onto the spatial light modulating element; and

a focusing optical system for focusing an image borne by the modulated light onto a photosensitive material, including: an optical system for focusing light beams which have been modulated by each of the pixel portions of the spatial light modulating element, to focus the image of each pixel portion; and a micro lens array, in which a plurality of micro lenses into which the light beams modulated by the pixel portions and passed through the optical system enter individually are provided;

the micro lens array being provided in the vicinity of the position at which the images of the pixel portions are focused by the optical system; and

each micro lens of the micro lens array having different powers in two directions within a plane perpendicular to the optical axis of the light beam that enters thereinto, in order to correct aberrations due to isotropic distortions of the pixel portions.

Note that the “vicinity of the position at which the images of the pixel portions are focused by the optical system” refers to a position z along the direction of the optical axis. The position z is within a range that satisfies the inequality:

−f/5+zf≦z≦f/5+zf

wherein: f is the focal distance of the optical system; and zf is the position at which the images of the pixel portions are focused by the optical system.

A second image exposure apparatus according to the present invention comprises:

a spatial light modulating element, in which a plurality of pixel portions for individually modulating light irradiated thereon according to control signals are provided;

a light source, for irradiating light onto the spatial light modulating element; and

a focusing optical system for focusing an image borne by the modulated light onto a photosensitive material, including: an optical system for focusing light beams which have been modulated by each of the pixel portions of the spatial light modulating element, to focus the image of each pixel portion; and a micro lens array, in which a plurality of micro lenses into which the light beams modulated by the pixel portions and passed through the optical system enter individually are provided;

the pixel portions having powers of different signs in two directions within a plane perpendicular to the optical axis of the light beam;

the micro lens array being provided at a separated condensing position, which is offset from a position at which the images of the pixel portions are focused by the optical system; and

each micro lens of the micro lens array having different powers in two directions within a plane perpendicular to the optical axis of the light beam that enters thereinto, in order to correct aberrations due to the powers of different signs of the pixel portions.

A third image exposure apparatus according to the present invention comprises:

a spatial light modulating element, in which a plurality of pixel portions for individually modulating light irradiated thereon according to control signals are provided;

a light source, for irradiating light onto the spatial light modulating element; and

a focusing optical system for focusing an image borne by the modulated light onto a photosensitive material, including: an optical system for focusing light beams which have been modulated by each of the pixel portions of the spatial light modulating element, to focus the image of each pixel portion; and a micro lens array, in which a plurality of micro lenses into which the light beams modulated by the pixel portions and passed through the optical system enter individually are provided;

the pixel portions having powers of the same sign and different magnitudes in two directions within a plane perpendicular to the optical axis of the light beam;

the micro lens array being provided at a separated condensing position, which is offset from a position at which the images of the pixel portions are focused by the optical system; and

each micro lens of the micro lens array having different powers in two directions within a plane perpendicular to the optical axis of the light beam that enters thereinto, in order to correct aberrations due to the powers of different magnitudes of the pixel portions.

Note that in the first through third image exposure apparatuses above, the micro lenses are not limited to being refractive lenses, and may be gradient index lenses or diffraction lenses. As a further alternative, the micro lenses may be structured by combining at least two of: refractive lenses; gradient index lenses; and diffraction lenses. Here, “combining” refers not only to cemented lenses, but also to single lenses which have been imparted with a plurality of functions. For example, a Fresnel lens is a combination of a refractive lens and a diffraction lens. As another example, a spherical lens having a refractive index distribution is a combination of a refractive lens and a gradient index lens.

It is preferable that a configuration is adopted, wherein the image exposure apparatuses further comprise:

a condensing micro lens array, in which a plurality of micro lenses for individually condensing the light beams which have propagated thereto via each of the pixel portions are provided, is provided at a separated condensing position of the pixel portions, the optical system, and the micro lens array, which is offset from a position at which the images of the pixel portions are focused by the optical system.

It is preferable for the condensing micro lens array to be movable in the direction of the optical axes of the light beams.

It is desirable for a configuration to be adopted, wherein the image exposure apparatuses further comprise:

an aperture array, in which a plurality of apertures for individually transmitting the light beams which have propagated thereto via each of the pixel portions are provided, is provided at a separated condensing position of the pixel portions, the optical system, and the micro lens array, which is offset from a position at which the images of the pixel portions are focused by the optical system.

Further, it is desirable for the spatial light modulating element to be a DMD (Digital Micro mirror Device), in which micro mirrors are arranged two dimensionally as the pixel portions.

Note that the aforementioned “separated condensing position” refers to a position, separated from the focusing position of the pixel portions by the optical system, at which light beams reflected by each of the pixel portions are condensed individually and separated according to the pixel portion by which they were reflected. Alternatively, the “separated condensing position” refers to a position at which the light beams reflected by each of the pixel portions are separated, according to the pixel portion by which they were reflected.

In the first image exposure apparatus of the present invention, each of the micro lenses of the micro lens array has different powers in two directions within a plane perpendicular to the optical axes, in order to correct aberrations that occur due to anisotropic distortions of the pixel portions. Therefore, even if the pixel portions of the spatial light modulating element has anisotropic distortions, the micro lenses of the micro lens array correct astigmatic aberrations caused by the distortions. Thereby, the beam waist positions in the X and Y directions of the light beams, which have been condensed by the micro lenses via the pixel portions, can be matched. Accordingly, the first image exposure apparatus of the present invention is capable of utilizing light beams having beam waist positions matched in the X and Y directions to expose images, thereby enabling obtainment of highly detailed images.

In addition, the first image exposure apparatus according to the present invention provides the micro lens array, for correcting astigmatic aberrations, in the vicinity of the position at which the images of the pixel portions are focused. Therefore, the range of the aforementioned separated condensing position, at which the light beams reflected by each of the pixel portions are condensed individually, is wide.

A configuration may be adopted, wherein the first image exposure apparatus of the present invention further comprises the condensing micro lens array for individually condensing the light beams reflected by each of the pixel portions, provided at the separated condensing position. In this case, the beam spot size can be further condensed, which contributes to improvement of the resolution of images exposed by the image exposure apparatus. In addition, the light beams are already condensed by the micro lens array provided in the vicinity of the focusing position. Therefore, the beam diameters of the light beams that enter the condensing micro lens array at the separated condensing position are smaller than those at the focusing position. Accordingly, eclipsing of the light beams and entrance of the light beams into micro lenses adjacent to those that they are intended to enter are prevented, even if the spatial light modulating element and the condensing micro lens array are shifted somewhat. Therefore, reductions in the light utilization efficiency and the extinction ratio, which need to be considered when providing the condensing micro lens array, are prevented.

The second image exposure apparatus of the present invention comprises the micro lens array provided at the aforementioned separated condensing position. The beam spots at the separated condensing position are smaller than those of the images of the pixel portions at the focusing position, and smaller than the micro lenses of the micro lens array. Accordingly, eclipsing of the light beams and entrance of the light beams into micro lenses adjacent to those that they are intended to enter are prevented, even if the spatial light modulating element and the condensing micro lens array are shifted somewhat. Therefore, reductions in the light utilization efficiency and the extinction ratio are prevented.

In addition, each of the micro lenses of the micro lens array have different powers in two directions within a plane perpendicular to the optical axes, to correct aberrations caused by the pixel portions having powers of different signs in two directions within a plane perpendicular to the optical axes. By adopting this configuration, the beam waist positions in the X and Y directions of the light beams can be matched, even if astigmatic aberrations occur due to the pixel portions. Accordingly, the second image exposure apparatus of the present invention is capable of utilizing light beams having beam waist positions matched in the X and Y directions to expose images, thereby enabling obtainment of highly detailed images.

The third image exposure apparatus of the present invention comprises the micro lens array, provided at the aforementioned separated condensing position. The beam spots at the separated condensing position are smaller than those of the images of the pixel portions at the focusing position, and smaller than the micro lenses of the micro lens array. Accordingly, eclipsing of the light beams and entrance of the light beams into micro lenses adjacent to those that they are intended to enter are prevented, even if the spatial light modulating element and the condensing micro lens array are shifted somewhat. Therefore, reductions in the light utilization efficiency and the extinction ratio are prevented.

In addition, each of the micro lenses of the micro lens array have different powers in two directions within a plane perpendicular to the optical axes, to correct aberrations caused by the pixel portions having different powers of the same sign in two directions within a plane perpendicular to the optical axes. By adopting this configuration, the beam waist positions in the X and Y directions of the light beams can be matched, even if astigmatic aberrations occur due to the pixel portions. Accordingly, the second image exposure apparatus of the present invention is capable of utilizing condensed light beams having beam waist positions matched in the X and Y directions to expose images, thereby enabling obtainment of highly detailed images.

A configuration may be adopted, wherein the second and third image exposure apparatuses of the present invention further comprise the condensing micro lens array, for individually condensing the light beams which have propagated thereto via each of the pixel portions, provided at the aforementioned separated condensing position. In this case, the beam spot size can be further condensed, which contributes to improvement of the resolution of images exposed by the image exposure apparatus. In addition, the light beams are already condensed by the micro lens array provided in the vicinity of the focusing position. Therefore, the beam diameters of the light beams that enter the condensing micro lens array at the separated condensing position are smaller than those at the focusing position. Accordingly, eclipsing of the light beams and entrance of the light beams into micro lenses adjacent to those that they are intended to enter are prevented, even if the spatial light modulating element and the condensing microlens array are shifted somewhat. Therefore, reductions in the light utilization efficiency and the extinction ratio, which need to be considered when providing the condensing micro lens array, are prevented.

The condensing micro lens array may be provided to be movable in the direction of the optical axes of the light beams. In this case, adjustments to the focal point of the light beams are facilitated. The variance in light utilization efficiency at the separated condensing position and the vicinity thereof is smaller than that at the focusing position and the vicinity thereof. Therefore, the variance in light utilization efficiency can be suppressed to a minimum.

In addition, the aperture array may be provided at the separated condensing position, in the first through third image exposure apparatuses of the present invention. In this case, each of the apertures transmits only the light beams which have been condensed via the corresponding pixel portions. Therefore, stray light can be shut out, and the extinction ratio can be improved.

Note that in the case that gradient index lenses are employed as the micro lenses in the first through third image exposure apparatuses of the present invention, the exterior shape can be formed as a parallel plane. In the case that diffraction lenses are employed as the micro lenses, the exterior shape can be formed as a parallel plane, while reducing the thickness in the direction of the optical axes, compared to a case in which refractive lenses are employed. In the case that combinations of at least two of refractive lenses, gradient index lenses, and diffraction lenses are employed, the degree of freedom in design increases.

### BRIEF DESCRIPTION OF THE DRAWINGS

FIG. 1 is a perspective view that illustrates the outer appearance of an image exposure apparatus according to a first embodiment of the present invention.

FIG. 2 is a perspective view that illustrates the construction of a scanner of the image exposure apparatus according to the first embodiment of the present invention.

FIG. 3A is a plan view that illustrates exposed regions, which are formed on a photosensitive material.

FIG. 3B is a diagram that illustrates the arrangement of exposure areas exposed by exposure heads.

FIG. 4 is a perspective view that illustrates the schematic construction of an exposure head of the image exposure apparatus according to the first embodiment of the present invention.

FIG. 5 is a schematic sectional view that illustrates the exposure head of the image exposure apparatus according to the first embodiment of the present invention.

FIG. 6 is a partial magnified diagram that illustrates the construction of a digital micro mirror device (DMD).

FIG. 7A is a diagram for explaining the operation of the DMD.

FIG. 7B is a diagram for explaining the operation of the DMD.

FIG. 8A is a plan view that illustrates the scanning trajectories of exposing beams in the case that the DMD is not inclined.

FIG. 8B is a plan view that illustrates the scanning trajectories of the exposing beams in the case that the DMD is inclined.

FIG. 9A is a perspective view that illustrates the construction of a fiber array light source.

FIG. 9B is a front view that illustrates the arrangement of light emitting points of laser emitting portions of the fiber array light source.

FIG. 10 is a diagram that illustrates the configuration of multi mode optical fibers.

FIG. 11 is a plan view that illustrates the construction of a multiplex laser light source.

FIG. 12 is a plan view that illustrates the construction of a laser module.

FIG. 13 is a side view of the laser module of FIG. 12.

FIG. 14 is a partial front view of the laser module of FIG. 12.

FIG. 15 is a block diagram that illustrates the electrical configuration of the image exposure apparatus according to the first embodiment of the present invention.

FIG. 16A is a diagram that illustrates an example of a utilized region of the DMD.

FIG. 16B is a diagram that illustrates an example of a utilized region of the DMD.

FIG. 17 is a diagram that illustrates the direction of a deflecting axis of a micro mirror of the DMD.

FIG. 18A is a graph that schematically illustrates the height displacement of a reflective surface of the micro mirror in a plane parallel to an x direction.

FIG. 18B is a graph that schematically illustrates the height displacement of a reflective surface of the micro mirror in a plane parallel to a y direction.

FIG. 19A is a diagram that illustrates how light reflected by the micro mirror propagates within a plane parallel to the x direction.

FIG. 19B is a diagram that illustrates how light reflected by the micro mirror propagates within a plane parallel to the y direction.

FIG. 20A is a front view of a micro lens array.

FIG. 20B is a side view of the micro lens array.

FIG. 21A is a perspective view of a micro lens of the micro lens array.

FIG. 21B is a view of a cross section of the micro lens parallel to the x direction.

FIG. 21C is a view of a cross section of the micro lens parallel to the y direction.

FIG. 22A is a diagram for explaining how the micro lens corrects aberrations.

FIG. 22B is a diagram for explaining how the micro lens corrects aberrations.

FIG. 22C is a diagram for explaining how the micro lens corrects aberrations.

FIG. 23A is a front view of a second example of the micro lens.

FIG. 23B is a side view of the second example of the micro lens.

FIG. 24A is a schematic diagram that illustrates the condensing state by the micro lens of FIGS. 23A and 23B, in a cross section parallel to the x direction.

FIG. 24B is a schematic diagram that illustrates the condensing state by the micro lens of FIGS. 23A and 23B, in a cross section parallel to the y direction.

FIG. 25A is a schematic diagram that illustrates the condensing state of a third example of the micro lens in a cross section parallel to the x direction.

FIG. 25B is a schematic diagram that illustrates the condensing state of the third example of the micro lens in a cross section parallel to the y direction.

FIG. 26A is a front view of a fourth example of the micro lens.

FIG. 26B is a side view of the fourth example of the micro lens.

FIG. 27A is a front view of a fifth example of the micro lens.

FIG. 27B is a side view of the fifth example of the micro lens.

FIG. 28 is a schematic sectional view that illustrates an exposure head of the image exposure apparatus according to a second embodiment of the present invention.

FIG. 29 is a schematic sectional view that illustrates an exposure head of the image exposure apparatus according to a third embodiment of the present invention.

FIG. 30 is a schematic sectional view that illustrates an exposure head of the image exposure apparatus according to a fourth embodiment of the present invention.

FIG. 31 is a schematic sectional view that illustrates an exposure head of the image exposure apparatus according to a fifth embodiment of the present invention.

FIG. 32A is a diagram for explaining how the micro lens corrects aberrations.

FIG. 32B is a diagram for explaining how the micro lens corrects aberrations.

FIG. 33A is a diagram for explaining the advantageous effects of the image exposure apparatus according to the fifth embodiment of the present invention.

FIG. 33B is a diagram for explaining the advantageous effects of the image exposure apparatus according to the fifth embodiment of the present invention.

FIG. 34A is a diagram for explaining the advantageous effects of the image exposure apparatus according to the fifth embodiment of the present invention.

FIG. 34B is a diagram for explaining the advantageous effects of the image exposure apparatus according to the fifth embodiment of the present invention.

FIG. 35 is a schematic sectional view that illustrates an exposure head of the image exposure apparatus according to a sixth embodiment of the present invention.

FIG. 36 is a schematic sectional view that illustrates an exposure head of the image exposure apparatus according to a seventh embodiment of the present invention.

FIG. 37 is a schematic sectional view that illustrates an exposure head of the image exposure apparatus according to an eighth embodiment of the present invention.

FIG. 38 is a schematic sectional view that illustrates an exposure head of the image exposure apparatus according to a ninth embodiment of the present invention.

FIG. 39A is a schematic diagram that illustrates distortion in the reflective surface of a micro mirror in the x direction.

FIG. 39B is a schematic diagram that illustrates distortion in the reflective surface of a micro mirror in the y direction.

FIG. 40A is a schematic diagram that illustrates how light reflected by the micro mirror propagates within a plane parallel to the x direction.

FIG. 40B is a schematic diagram that illustrates how light reflected by the micro mirror propagates within a plane parallel to the y direction.

FIG. 41A is a diagram for explaining how the micro lens corrects aberrations.

FIG. 41B is a diagram for explaining how the micro lens corrects aberrations.

FIG. 42A is a front view of a sixth example of a micro lens.

FIG. 42B is a side view of the sixth example of a micro lens.

FIG. 43A is a schematic diagram that illustrates the condensing state by the micro lens of FIGS. 42A and 42B, in a cross section parallel to the x direction.

FIG. 43B is a schematic diagram that illustrates the condensing state by the micro lens of FIGS. 42A and 42B, in a cross section parallel to the y direction.

FIG. 44A is a diagram for explaining how the micro lens corrects aberrations.

FIG. 44B is a diagram for explaining how the micro lens corrects aberrations.

FIG. 45 is a schematic sectional view that illustrates an exposure head of the image exposure apparatus according to a tenth embodiment of the present invention.

FIG. 46 is a schematic sectional view that illustrates an exposure head of the image exposure apparatus according to an eleventh embodiment of the present invention.

FIG. 47 is a schematic sectional view that illustrates an exposure head of the image exposure apparatus according to a twelfth embodiment of the present invention.

FIGS. 48A and 48B are diagrams for explaining the problems associated with conventional image exposure apparatuses.

FIGS. 49A and 49B are diagrams for explaining the problems associated with conventional image exposure apparatuses.

### BEST MODE FOR CARRYING OUT THE INVENTION

Hereinafter, preferred embodiments of the present invention will be described in detail with reference to the attached drawings. First, an image exposure apparatus according to a first embodiment of the present invention will be described.

### [Configuration of the Image Exposure Apparatus]

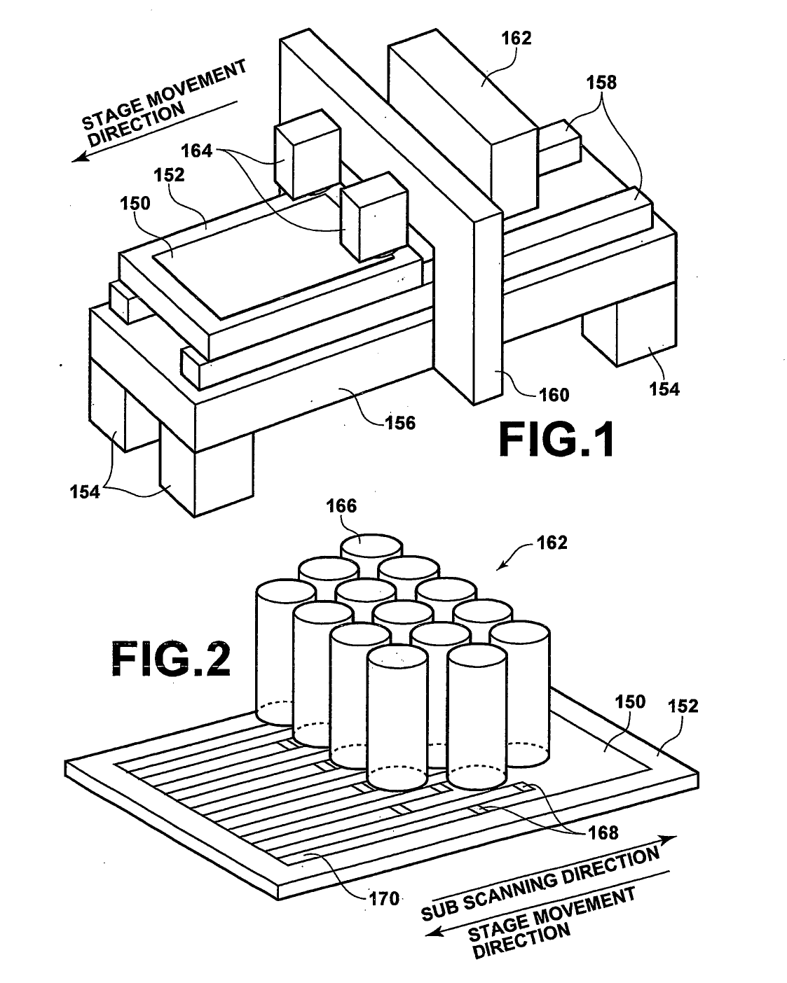

As illustrated in FIG. 1, the image exposure apparatus is equipped with a planar moving stage 152, for holding sheets of photosensitive material 150 thereon by suction. Amounting base 156 is supported by four legs 154. Two guides 158 that extend along the stage movement direction are provided on the upper surface of the mounting base 156. The stage 152 is provided such that its longitudinal direction is aligned with the stage movement direction, and supported by the guides 158 so as to be movable reciprocally thereon. Note that the image exposure apparatus is also equipped with a stage driving apparatus 304 (refer to FIG. 15), as a sub scanning means for driving the stage 152 along the guides 158.

A C-shaped gate 160 is provided at the central portion of the mounting base so as to straddle the movement path of the stage 152. The ends of the C-shaped gate 160 are fixed to side edges of the mounting base 156. A scanner 162 is provided on a first side of the gate 160, and a plurality (two, for example) of sensors 164 for detecting the leading and trailing ends of the photosensitive material 150 are provided on a second side of the gate 160. The scanner 162 and the sensors 164 are individually mounted on the gate 160, and fixed above the movement path of the stage 152. Note that the scanner 162 and the sensors 164 are connected to a controller (not shown) for controlling the operations thereof.

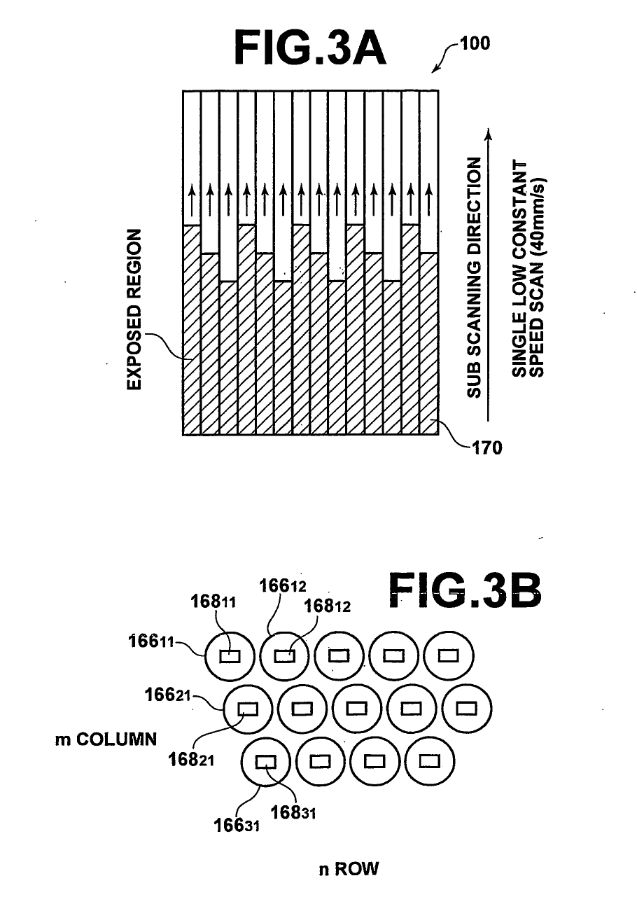

The scanner 162 is equipped with a plurality (14, for example) of exposure heads 166, arranged in an approximate matrix having m rows and n columns (3 rows and 5 columns, for example), as illustrated in FIG. 2 and FIG. 3B. In this example, four exposure heads 166 are provided in the third row, due to constraints imposed by the width of the photosensitive material 150. Note that an individual exposure head arranged in an m^{th} row and an n^{th} column will be denoted as an exposure head 166ₘₙ.

An exposure area 168, which is exposed by the exposure heads 166, is a rectangular area having its short sides in the sub-scanning direction. Accordingly, band-like exposed regions 170 are formed on the photosensitive material 150 by each of the exposure heads 166, accompanying the movement of the stage 152. Note that an individual exposure area, exposed by an exposure head arranged in an m^{th} row and an n^{th} column will be denoted as an exposure area 168_{m, n}.

As illustrated in FIG. 3B, each of the rows of the exposure heads 166 is provided staggered a predetermined interval (a natural number multiple of the long side of the exposure area, 2 times in the present embodiment) with respect to the other rows. This is to ensure that the band-like exposed regions 170 have no gaps therebetween in the direction perpendicular to the sub scanning direction, as illustrated in FIG. 3A. Therefore, the portion between an exposure area 168_{1, 1} and 168_{1, 2} of the first row, which cannot be exposed thereby, can be exposed by an exposure area 168_{2, 1} of the second row and an exposure area 168_{3, 1} of the third row.

Each of the exposure heads 166_{1, 1} through 168_{m, n} are equipped with a DMD 50 (Digital Micro mirror Device) by Texas Instruments (U.S.), for modulating light beams incident thereon according to each pixel of image data. The DMD's 50 are connected to a controller 302 to be described later (refer to FIG. 15), comprising a data processing section and a mirror drive control section. The data processing section of the controller 302 generates control signals for controlling the drive of each micro mirror of the DMD 50 within a region that should be controlled for each exposure head 166, based on input image data. Note that the “region that should be controlled” will be described later. The mirror drive control section controls the angle of a reflective surface of each micro mirror of the DMD 50 for each exposure head 166, according to the control signals generated by the data processing section. Note that control of the angle of the reflective surface will be described later.

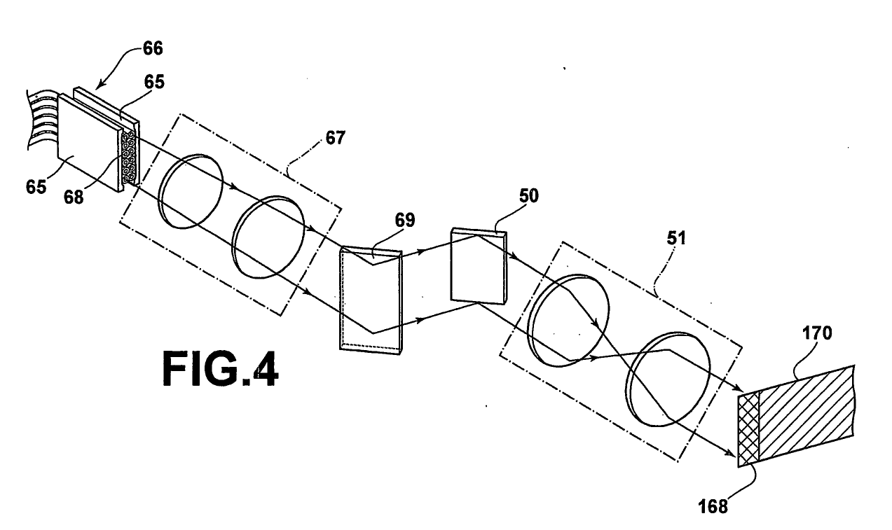

A fiber array light source 66; an optical system 67; and a mirror 69 are provided in this order, at the light incident side of the DMD 50. The fiber array light source 66 comprises a laser emitting section, constituted by a plurality of optical fibers having their light emitting ends (light emitting points) aligned in a direction corresponding to the longitudinal direction of the exposure area 168. The optical system 67 corrects laser beams emitted from the fiber array light source 66 to condense them onto the DMD 50. The mirror 69 reflects the laser beams, which have passed through the optical system 67, toward the DMD 50. Note that the optical system 67 is schematically illustrated in FIG. 4.

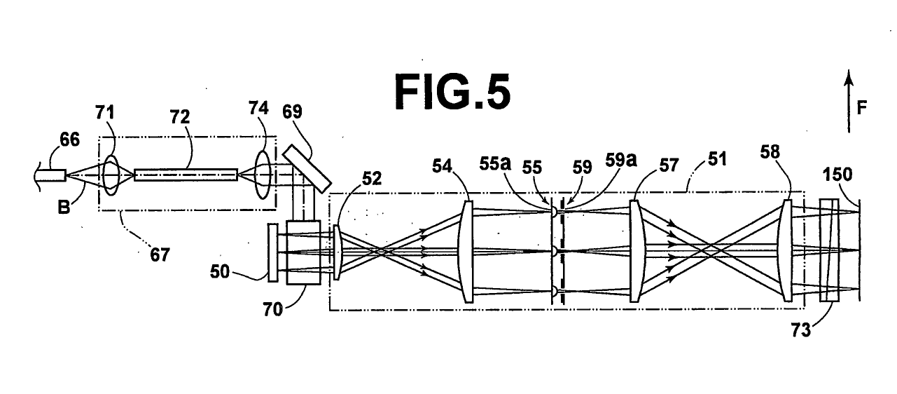

As illustrated in detail in FIG. 5, the optical system 67 comprises: a condensing lens 71, for condensing the laser beams B emitted from the fiber array light source 66 as illuminating light; a rod-like optical integrator 72 (hereinafter, referred to simply as “rod integrator 72”), which is inserted into the optical path of the light which has passed through the condensing lens 71; and a collimating lens 74, provided downstream from the rod integrator 72, that is, toward the side of the mirror 69. The condensing lens 71, the rod integrator 72 and the collimating lens 74 cause the laser beams emitted from the fiber array light source to enter the DMD 50 as a light beam which is close to collimated light and which has uniform beam intensity across its cross section. The shape and the operation of the rod integrator 72 will be described in detail later.

The laser beam B emitted through the optical system 67 is reflected by the mirror 69, and is irradiated onto the DMD 50 via a TIR (Total Internal Reflection) prism 70. Note that the TIR prism 70 is omitted from FIG. 4.

A focusing optical system 51, for focusing the laser beam B reflected by the DMD 50 onto the photosensitive material 150, is provided on the light reflecting side of the DMD 50. The focusing optical system 51 is schematically illustrated in FIG. 4, but as illustrated in detail in FIG. 5, the focusing optical system 51 comprises: a first focusing optical system constituted by lens systems 52 and 54; a second focusing optical system constituted by lens systems 57 and 58; a micro lens array 55; and an aperture array 59. The micro lens array 55 and the aperture array 59 are provided between the first focusing optical system and the second focusing optical system.

The micro lens array 55 is constituted by a great number of micro lenses 55a, which are arranged two dimensionally, corresponding to each pixel of the DMD 50. In the present embodiment, only 1024×256 columns out of 1024×768 columns of micro mirrors of the DMD 50 are driven, as will be described later. Therefore, 1024×256 columns of micro lenses 55a are provided, corresponding thereto. The arrangement pitch of the micro lenses 55a is 41 μm in both the vertical and horizontal directions. The micro lenses 55a are formed by optical glass BK7, and have focal distances of 0.19 mm and NA's (Numerical Apertures) of 0.11, for example. Note that the shapes of the micro lenses 55a will be described in detail later. The beam diameter of each laser beams B at the position of each micro lens 55a is 41 μm.

The aperture array 59 has a great number of apertures 59a formed therethrough, corresponding to the micro lenses 55a of the micro lens array 55. In the present embodiment, the diameter of the apertures 59a is 10 μm.

The first focusing optical system magnifies the images that propagate thereto from the DMD 50 by 3× and focuses the images on the micro lens array 55. The second focusing optical system magnifies the images that have passed through the micro lens array 55 by 1.6×, and focuses the images onto the photosensitive material 150. Accordingly, the images from the DMD 50 are magnified at 4.8× magnification and projected onto the photosensitive material 150.

Note that in the present embodiment, a prism pair 73 is provided between the second focusing optical system and the photosensitive material 150. The focus of the image on the photosensitive material 150 is adjustable, by moving the prism pair 73 in the vertical direction in FIG. 5. Note that in FIG. 5, the photosensitive material 150 is conveyed in the direction of arrow F to perform sub-scanning.

The DMD 50 is a mirror device having a great number (1024×768, for example) of micro mirrors 62, each of which constitutes a pixel, arranged in a matrix on an SRAM cell 60 (memory cell). A micro mirror 62 supported by a support column is provided at the uppermost part of each pixel, and a material having high reflectivity, such as aluminum, is deposited on the surface of the micro mirror 62 by vapor deposition. Note that the reflectivity of the micro mirrors 62 is 90% or greater, and that the arrangement pitch of the micro mirrors 62 is 13.7 μm in both the vertical and horizontal directions. In addition, the CMOS SRAM cell 60 of a silicon gate, which is manufactured in a normal semiconductor memory manufacturing line, is provided beneath the micro mirrors 62, via the support column, which includes a hinge and a yoke. The DMD 50 is of a monolithic structure.

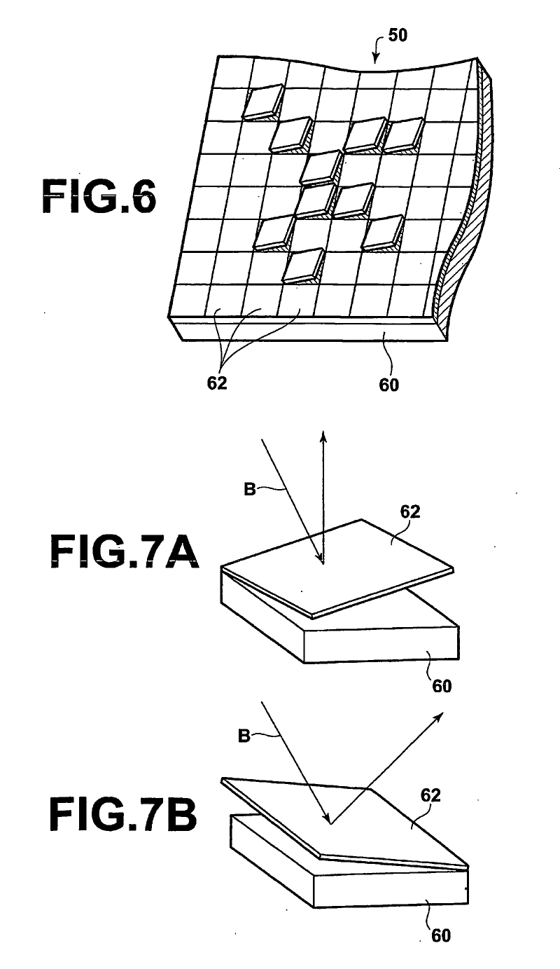

When digital signals are written into the SRAM cell 60 of the DMD 50, the micro mirrors 62 which are supported by the support columns are tilted within a range of ±α degrees (±12 degrees, for example) with respect to the substrate on which the DMD 50 is provided, with the diagonal line as the center of rotation. FIG. 7A illustrates a state in which a micro mirror 62 is tilted ±α degrees in an ON state, and FIG. 7B illustrates a state in which a micro mirror 62 is tilted −α degrees in an OFF state. Accordingly, laser light beams incident on the DMD 50 are reflected toward the direction of inclination of each micro mirror 62, by controlling the tilt of each micro mirror 62 that corresponds to a pixel of the DMD 50 according to image signals, as illustrated in FIG. 6.

Note that FIG. 6 illustrates a magnified portion of a DMD 50 in which the micro mirrors 62 are controlled to be tilted at +α degrees and at −α degrees. The ON/OFF operation of each micro mirror 62 is performed by the controller 302, which is connected to the DMD 50. In addition, a light absorbing material (not shown) is provided in the direction toward which laser beams B reflected by micro mirrors 62 in the OFF state are reflected. The micro mirrors 62 of the present embodiment have distortions in their reflective surfaces. However, the distortions are omitted from FIGS. 6, 7A, and 7B.

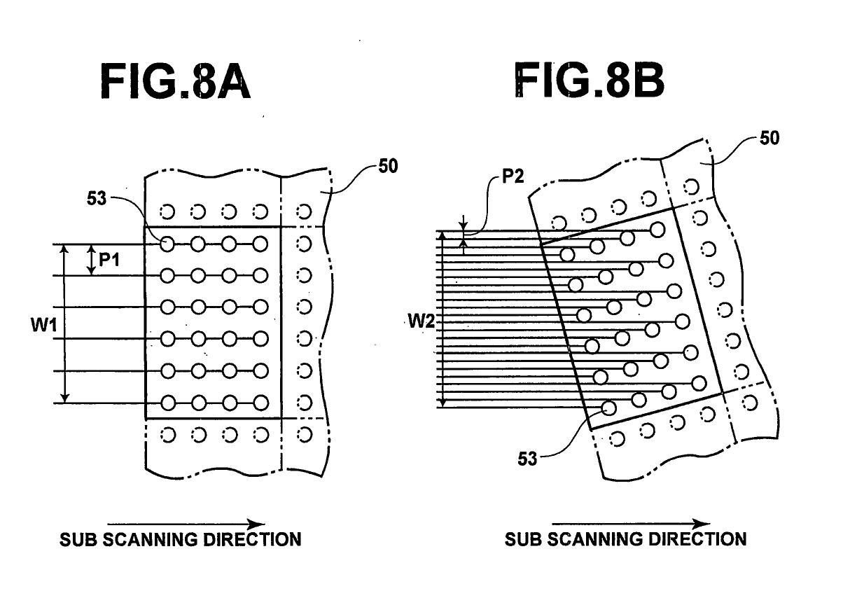

It is preferable for the DMD 50 to be provided such that its short side is inclined at a slight predetermined angle (0.1° to 5°, for example) with respect to the sub-scanning direction. FIG. 8A illustrates scanning trajectories of reflected light images 53 (exposing beams) of each micro mirror in the case that the DMD 50 is not inclined, and FIG. 8B illustrates the scanning trajectories of the exposing beams 53 in the case that the DMD 50 is inclined.

A great number (756, for example) of columns of rows of a great number (1024, for example) of micro mirrors aligned in the longitudinal direction, are provided in the lateral direction of the DMD 50. As illustrated in FIG. 8B, by inclining the DMD 50, the pitch P₂ of the scanning trajectories (scanning lines) of the exposure beams 53 become narrower than the pitch P₁ of the scanning lines in the case that the DMD 50 is not inclined. Therefore, the resolution of the image can be greatly improved. Meanwhile, because the angle of inclination of the DMD 50 is slight, the scanning width W₂ in the case that the DMD 50 is inclined and the scanning width W₁ in the case that the DMD is not inclined are substantially the same.

In addition, the same scanning lines are repeatedly exposed (multiple exposure) by different micro mirror columns. By performing multiple exposure in this manner, it becomes possible to finely control exposure positions with respect to alignment marks, and to realize highly detailed exposure. Seams among the plurality of exposure heads, which are aligned in the main scanning direction, can be rendered virtually seamless by finely controlling the exposure positions.

Note that the micro mirror columns may be shifted by predetermined intervals in the direction perpendicular to the sub-scanning direction to be in a staggered formation instead of inclining the DMD 50, to achieve the same effect.

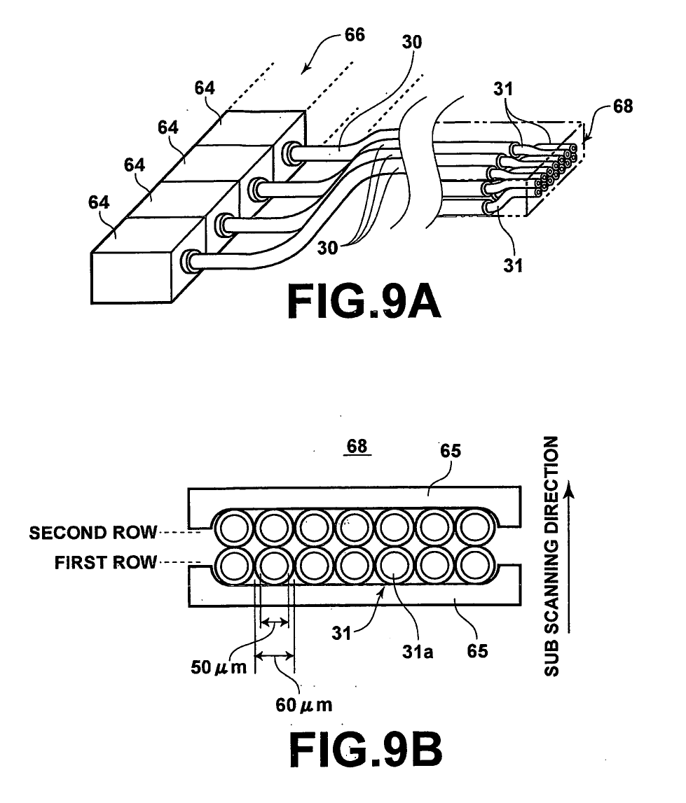

As illustrated in FIG. 9A, the fiber array light source 66 is equipped with a plurality (14, for example) of laser modules 64. An end of a multi mode optical fiber 30 is coupled to each laser module 64. An optical fiber 31, having the same core diameter as the multi mode optical fiber 30 and a cladding diameter smaller than that of the multi mode optical fiber 30, is coupled to the other end of each multi mode optical fiber 30. As illustrated in detail in FIG. 9B, the optical fibers 31 are arranged such that seven ends of the optical fibers 30 opposite the end at which they are coupled to the multi mode optical fibers are aligned along the main scanning direction perpendicular to the sub scanning direction. Two rows of the seven optical fibers 31 constitute a laser emitting section 68.

As illustrated in FIG. 9B, the laser emitting section 68, constituted by the ends of the optical fibers 31, is fixed by being sandwiched between two support plates 65, which have flat surfaces. It is desirable for a transparent protective plate, such as that made of glass, to be placed at the light emitting end surfaces of the optical fibers 31. The light emitting end surfaces of the optical fibers 31 are likely to collect dust due to their high optical density and therefore likely to deteriorate. However, by placing the protective plate as described above, adhesion of dust to the end surfaces can be prevented, and deterioration can be slowed.

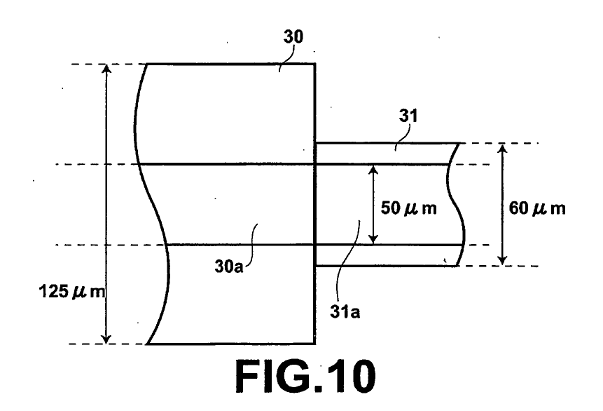

In the present embodiment, the optical fiber 31 having a small cladding diameter and a length of approximately 1 to 30 cm is coaxially coupled to the light emitting end of the multi mode optical fiber 30 having a large cladding diameter, as illustrated in FIG. 10. Each pair of the optical fibers 30 and 31 are coupled by fusing the light incident end surface of the optical fiber 31 with the light emitting end surface of the multi mode optical fiber 30 such that the core axes thereof are matched. As described above, the diameter of the core 31a of the optical fiber 31 is the same as the diameter of the core 30a of the multi mode optical fiber 30.

Step index type optical fibers, graded index type optical fibers, or combined type optical fibers may be employed as the multi mode optical fibers 30 and the optical fibers 31. Step index type optical fibers produced by Mitsubishi Wire Industries KK may be employed, for example. In the present embodiment, the multi mode optical fibers 30 and the optical fibers 31 are step index type optical fibers. The multi mode optical fiber 30 has a cladding diameter of 125 μm, a core diameter of 50 μm, and an NA of 0.2. The optical fiber 30 has a cladding diameter of 60 μm, a core diameter of 50 μm, and an NA of 0.2. The transmissivity of the coating at the light incident end surface of the multi mode optical fiber 30 is 99.5% or greater.

The cladding diameter of the optical fiber 31 is not limited to being 60 μm. The cladding diameters of many optical fibers, which are utilized in conventional fiber light sources, are 125 μm. However, the focal depth becomes deeper as the cladding diameter decreases. Therefore, it is preferable for the cladding layer of a multi mode optical fiber to be 80 μm or less, and more preferably, 60 μm or less. Meanwhile, in the case of a single mode optical fiber, it is necessary for the core diameter to be at least 3 to 4 μm. Therefore, it is preferable for the cladding diameter of the optical fiber 31 to be 10 μm or greater. It is preferable for the core diameter of the multi mode optical fiber 30 and the core diameter of the optical fiber 31 to be matched, from the viewpoint of coupling efficiency.

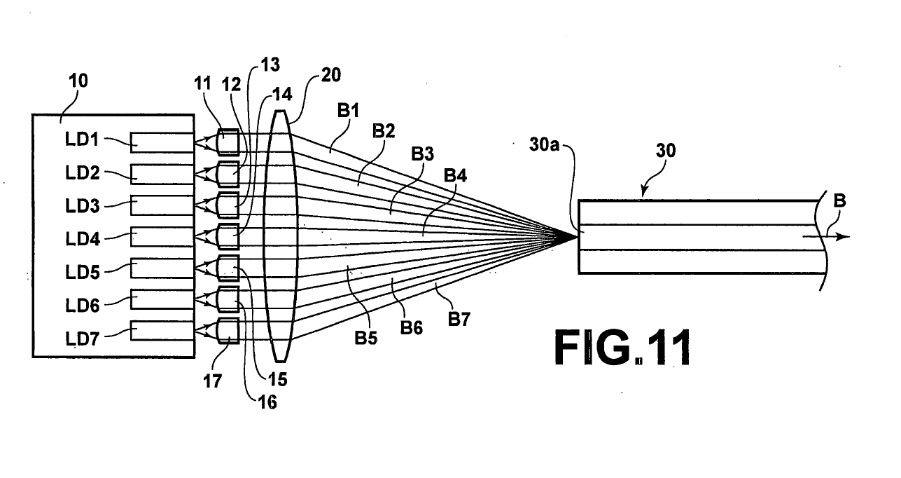

Each of the laser modules 64 is constituted by the multiplex laser light source (fiber light source) illustrated in FIG. 11. The multiplex laser light source comprises: a heat block 10; a plurality (seven, for example) GaN type semiconductor laser chips LD1, LD2, LD3, LD4, LD5, LD6, and LD7, which are aligned and fixed on the heat block 10; collimating lenses 11, 12, 13, 14, 15, 16, and 17, provided corresponding to each of the GaN type semiconductor lasers LD1 through LD7; a single condensing lens 20; and a single multi mode fiber 30. The GaN type semiconductor laser chips may be transverse multi mode laser chips or single mode laser chips. Note that the number of semiconductor lasers is not limited to 7, and any number of semiconductor lasers may be employed. In addition, a collimating lens array, in which the collimating lenses 11 through 17 are integrated, may be employed instead of the collimating lenses 11 through 17.

All of the GaN type semiconductor lasers LD1 through LD7 have the same oscillating wavelength (405 nm, for example), and the same maximum output (in the case of multi mode lasers, approximately 100 mW, and in the case of single mode lasers, approximately 50 mW). Note that the GaN semiconductors may have any oscillating wavelengths other than 405 nm, within a wavelength range of 350 nm to 450 nm.

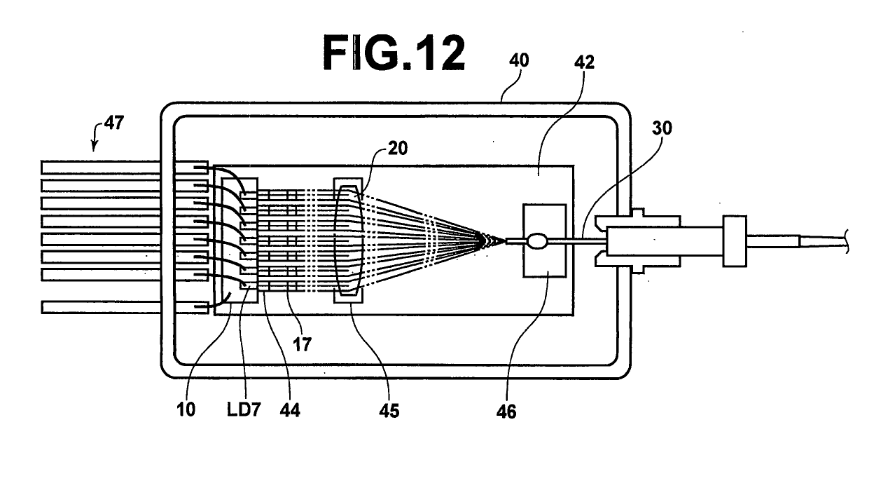

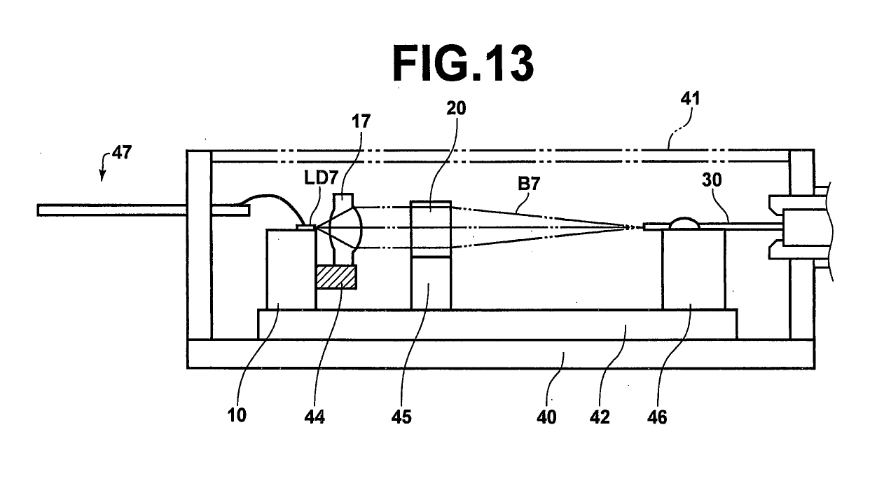

As illustrated in FIGS. 12 and 13, the multiplex laser light source is housed within a box-shaped package 40 having an open top, along with other optical components. The package 40 is equipped with a package lid 41, formed to seal the open top. The package 40 is deaerated, sealing gas is introduced, and the package lid 41 is placed on the package. Thereby, the multiplex laser light source is hermetically sealed within the closed space (sealed space) of the package 40.

A base plate 42 is fixed on the bottom surface of the package 40. The heat block 10, a condensing lens holder 45 for holding the condensing lens 20, and a fiber holder 46 for holding the light incident end of the multi mode optical fiber 30 are mounted on the base plate 42. The light emitting end of the multi mode optical fiber 30 is pulled out to the exterior of the package 40 through an opening formed in a wall thereof.

A collimating lens holder 44 is mounted on a side surface of the heat block 10, and the collimating lenses 11 through 17 are held thereby. An opening is formed in a side wall of the package 40, and wires 47 for supplying drive current to the GaN type semiconductor lasers LD1 through LD7 are pulled out toward the exterior of the package 40 therethrough.

Note that in FIG. 13, only the GaN type semiconductor laser LD7 and the collimating lens 17 are labeled with reference numbers, in order to avoid complexity in the drawing.

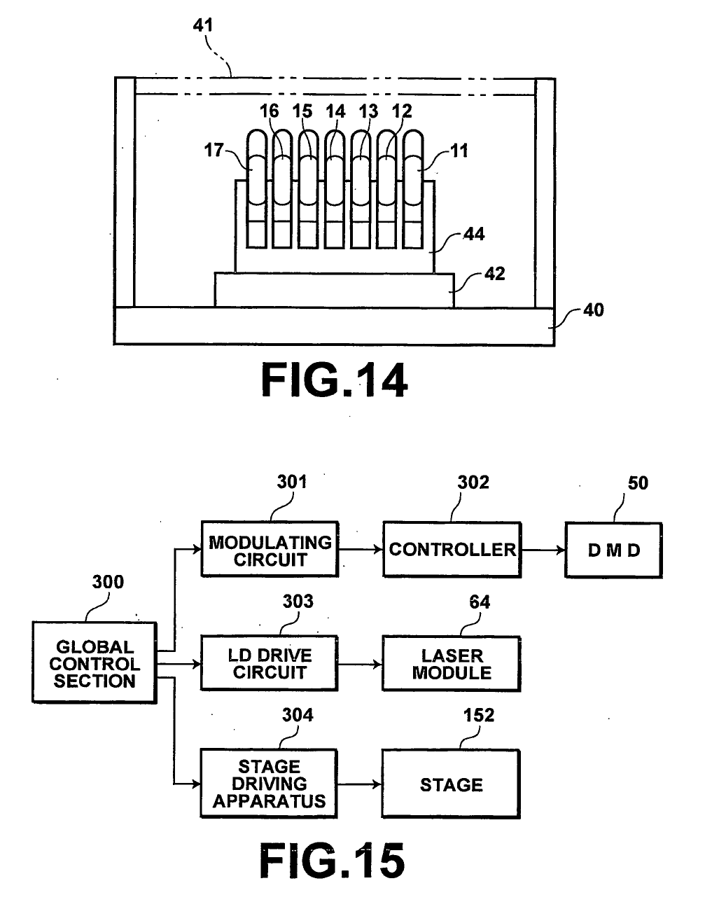

FIG. 14 is a front view of the mounting portions of the collimating lenses 11 through 17. Each of the collimating lenses 11 through 17 is formed to be of an elongate shape, obtained by cutting out a region that includes the optical axis of a circular lens having an aspherical surface. The elongate collimating lenses may be formed by molding resin or optical glass, for example. The collimating lenses 11 through 17 are densely provided and such that their longitudinal directions are perpendicular to the arrangement direction of the light emitting points of the GaN type semiconductor lasers LD1 through LD7 (the horizontal direction in FIG. 14).

The GaN type semiconductor lasers LD1 through LD7 comprise active layers having light emitting widths of 2 μm. Laser beams B1 through B7 having beam spread angles of 10 degrees and 30 degrees in the direction parallel to the active layer and the direction perpendicular to the active layer, respectively, are emitted from the GaN type semiconductor lasers LD1 through LD7. The GaN type semiconductor lasers LD1 through LD7 are provided such that the light emitting points thereof are aligned in a direction parallel to the active layers thereof.

Accordingly, the laser beams B1 through B7 are emitted from each of the light emitting points such that they enter the collimating lenses 11 through 17 in a state in which the directions that their beam spread angles are greater match the lengthwise directions of the collimating lenses 11 through 17, and in which the directions that their beam spread angles are smaller match the width directions of the collimating lenses 11 through 17. The widths and lengths of each of the collimating lenses 11 through 17 are 1.1 mm and 4.6 mm, respectively. The beam diameters of the laser beams B1 through B7 in the horizontal direction and the vertical direction are 0.9 mm and 2.6 mm, respectively. The collimating lenses 11 through 17 have focal distances f₁ of 3 mm, numerical apertures NA of 0.6, and are arranged at a pitch of 1.25 mm.

The condensing lens 20 is obtained by cutting out an elongate region that includes the optical axis of a circular lens having an aspherical surface at parallel planes. The condensing lens 20 is formed such that it is long in the arrangement direction of the collimating lenses 11 through 17, that is, the horizontal direction, and short in the direction perpendicular to the arrangement direction. The condensing lens 20 has a focal distance f₂ of 23 mm, and a numerical aperture NA of 0.2. The condensing lens 20 may also be formed by molding resin or optical glass, for example.

Next, the electrical configuration of the image exposure apparatus of the present embodiment will be described with reference to FIG. 15. As illustrated in FIG. 15, a total control section 300 is connected to a modulating circuit 301, which in turn is connected to the controller 302 for controlling the DMD's 50. The total control section 300 is also connected to a LD drive circuit 303, for driving the laser modules 64. Further, the total control section 300 is connected to the stage driving apparatus 304, for driving the stage 152.

### [Operation of the Image Exposure Apparatus]

Next, the operation of the image exposure apparatus described above will be described. The laser beams B1 through B7 are emitted by each of the GaN semiconductor lasers LD1 through LD7 (refer to FIG. 11) that constitute the multiplex laser light source of the fiber array light source 66 in a diffuse state. The laser beams B1 through B7 are collimated by the collimating lens corresponding thereto, from among the collimating lenses 11 through 17. The collimated laser beams B5 through B7 are condensed by the condensing lens 20, and are converged onto the light incident surface of the core 30a of the multi mode optical finer 30.

In the present embodiment, the collimating lenses 11 through 17 and the condensing lens 20 constitute a condensing optical system, and the condensing optical system and the multi mode optical fiber 30 constitute a multiplex optical system. That is, the laser beams B5 through B7, which have been condensed by the condensing lens 20 enter the core 30a of the multi mode optical fiber 30, are multiplexed into a single laser beam B, and emitted from the optical fiber 31, which is coupled to the light emitting end of the multi mode optical fiber 30.

The coupling efficiency of the laser beams B1 through B7 with respect to the multi mode optical fiber 30 is 0.9 in each of the laser modules. In the case that the output of each of the GaN type semiconductor lasers LD1 through LD7 is 50 mW, a multiplexed laser beam B having an output of 315 mW (50 mW×0.9×7) can be obtained from each of the optical fibers 31 which are provided in the array. Accordingly, a laser beam B having an output of 4.4 W (0.315 W×14) can be obtained from the 14 combined optical fibers 31.

During image exposure, image data corresponding to an exposure pattern is input to the controller 302 of the DMD's 50 from the modulating circuit 301. The image data is temporarily stored in a frame memory of the controller 302. The image data represents the density of each pixel that constitutes an image as binary data (dot to be recorded/dot not to be recorded).

The stage 152, on the surface of which the photosensitive material 150 is fixed by suction, is conveyed along the guides 158 from the upstream side to the downstream side of the gate 160 by the stage driving apparatus 304 illustrated in FIG. 15. When the stage 152 passes under the gate 160, the leading edge of the photosensitive material is detected by the sensors 164, which are mounted on the gate 160. Then, the image data recorded in the frame memory is sequentially read out a plurality of lines at a time. Control signals are generated by the signal processing section for each exposure head 166, based on the read out image data. Thereafter, the mirror driving control section controls the ON/OFF states of each micro mirror of the DMD's 50 of each exposure head, based on the generated control signals. Note that in the present embodiment, the size of each micro mirror that corresponds to a single pixel is 14 μm×14 μm.

When the laser beam B is irradiated onto the DMD's 50 from the fiber array light source 66, laser beams which are reflected by micro mirrors in the ON state are focused on the photosensitive material 150 by the lens systems 54 and 58. The laser beams emitted from the fiber array light source 66 are turned ON/OFF for each pixel, and the photosensitive material 150 is exposed in pixel units (exposure areas 168) substantially equal to the number of pixels of the DMD's 50 in this manner. The photosensitive material 150 is conveyed with the stage 152 at the constant speed. Sub-scanning is performed in the direction opposite the stage moving direction by the scanner 162, and band-shaped exposed regions 170 are formed on the photosensitive material 150 by each exposure head 166.

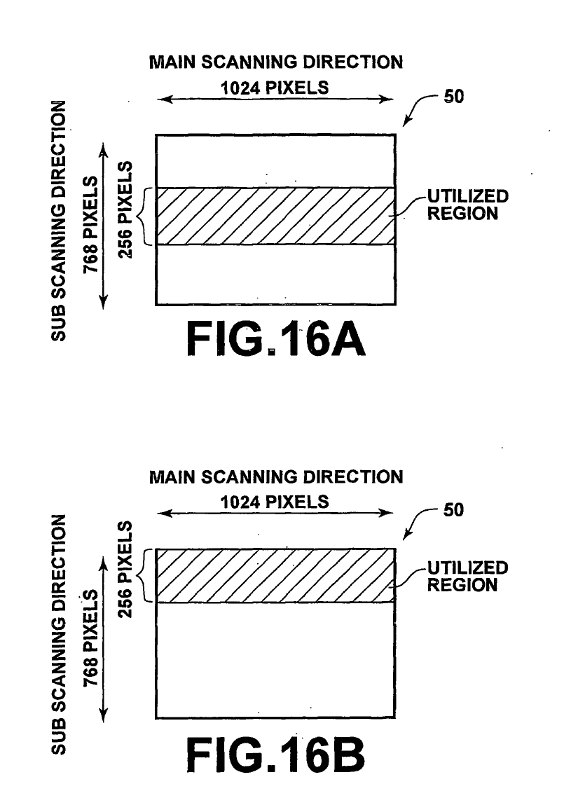

Note that in the present embodiment, 768 columns of micro mirror rows having 1024 micro mirrors therein are provided on each DMD 50 in the sub scanning direction, as illustrated in FIGS. 16A and 16B. However, only a portion of the micro mirror columns (256 columns of 1024 micro mirrors, for example) is driven by the controller 302.

In this case, the micro mirror columns situated at the central portion of the DMD 50 may be utilized, as illustrated in FIG. 16A. Alternatively, the micro mirror columns situated at the edge of the DMD 50 may be utilized, as illustrated in FIG. 16B. In addition, the micro mirror columns to be utilized may be changed as appropriate, in cases that defects occur in a portion of the micro mirrors and the like.

The data processing speed of the DMD's 50 is limited, and the modulation speed for each line is determined proportionate to the number of utilized pixels. Therefore, the modulation speed is increased by utilizing only a portion of the micro mirror columns. Meanwhile, in the case that an exposure method is adopted in which the exposure heads are continuously moved with respect to the exposure surface, it is not necessary to utilize all of the pixels in the sub scanning direction.

When sub scanning of the photosensitive material 150 by the scanner 162 is completed and the trailing edge of the photosensitive material 150 is detected by the sensors 162, the stage 152 is returned to its starting point at the most upstream side of the gate 160 along the guides 152 by the stage driving apparatus 304. Then, the stage 152 is moved from the upstream side to the downstream side of the gate 160 at the constant speed again.

### [Details of the Optical Systems of the Image Exposure Apparatus]

Next, an illuminating optical system for irradiating the laser beam B onto the DMD's 50, comprising: the fiber array 66, the condensing lens 71, the rod integrator 72, the collimating lens 74, the mirror 69, and the TIR prism 70 illustrated in FIG. 5 will be described. The rod integrator 72 is a light transmissive rod, formed as a square column, for example. The laser beam B propagates through the interior of the rod integrator 72 while being totally reflected therein, and the intensity distribution within the cross section of the laser beam B is uniformized. Note that an anti-reflective film is coated on the light incident surface and the light emitting surface of the rod integrator 72, to increase the transmissivity thereof. By uniformizing the intensity distribution within the cross section of the laser beam B in this manner, unevenness in the intensity of the illuminating light can be eliminated, and highly detailed images can be exposed on the photosensitive material 150.

FIG. 17 illustrates the direction of a deflecting axis, which is the central axis about which a micro mirror 62 of the DMD 50 rotates. In the present embodiment, one of the diagonals of the reflective surface of the micro mirror 62 is the direction of the deflecting axis. This direction is designated as a y direction, and the other diagonal is designated as an x direction. That is, the x direction and the y direction are two different directions within a plane perpendicular to an optical axis O, and the two different directions are perpendicular in the present embodiment.

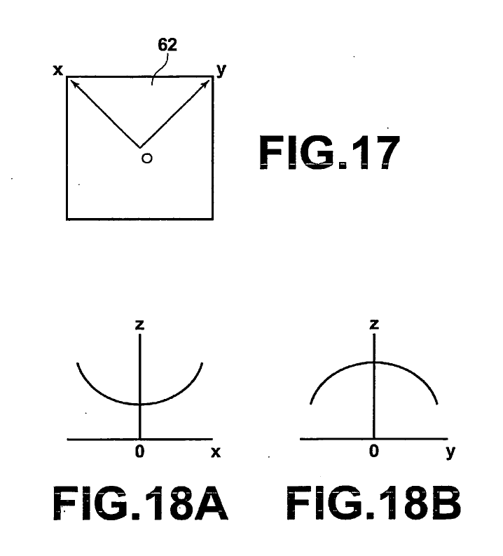

FIG. 18A and FIG. 18B are graphs that schematically illustrate the height displacement of the reflective surface of the micro mirror 62 in planes parallel to the x direction and the y direction, respectively. In FIG. 18A and FIG. 18B, the horizontal axes of the graphs represent distances from the center of the reflective surface in the respective directions, and the vertical axes represent displacement in the direction of the optical axis. As illustrated in FIG. 18A and FIG. 18B, the reflective surface of the micro mirror 62 is a curved surface having a concave shape in the x direction and a convex shape in the y direction. That is, the reflective surface is a rotationally asymmetrical curved surface, and has an anisotropic distortion. Due to this shape, the micro mirror 62 is of a rotationally asymmetrical structure that has powers of different signs in the x direction and the y direction.

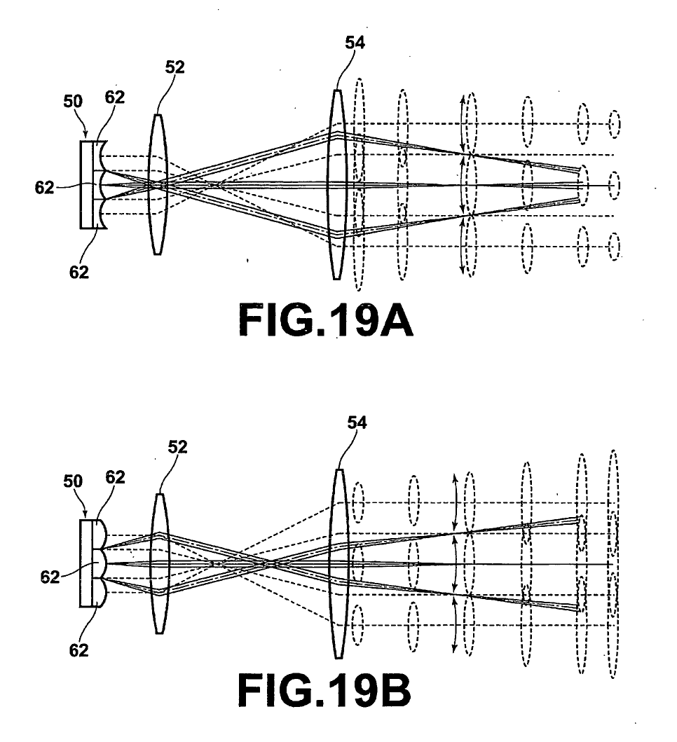

If collimated light is irradiated onto the micro mirror 62 having the powers of different signs as described above, the reflected light will be convergent in the x direction and divergent in the y direction. FIG. 19A and FIG. 19B are diagrams that illustrate how light reflected by the aforementioned micro mirror 62 propagates through the lens systems 52 and 54 that constitute the first focusing system, within planes parallel to the x direction and the y direction, respectively.

Note that the lens systems 52 and 54 have rotationally symmetrical powers with respect to the optical axis. The TIR prism 70 and the micro lens array 55 are omitted from FIG. 19A and FIG. 19B. Three adjacent micro mirrors 62 are illustrated in FIG. 19A and FIG. 19B. The images borne by the light reflected by each of the micro mirrors 62 are denoted by the curved arrows, and the light beams reflected by the center and the edges of the central micro mirror 62 are denoted by solid lines. In addition, the manner in which the beam diameters of the beams reflected by the three micro mirrors 62 change as the beams propagate downstream from the lens system 54 is denoted by the ovals illustrated by broken lines in FIG. 19A and FIG. 19B.

In the case that light that converges in the x direction and diverges in the y direction as described above is condensed by a normal lens, which has a power rotationally symmetrical with respect to the optical axis, the position in the direction of the optical axis at which the beam diameter is minimal (beam waist position) is different in the x direction and the y direction. That is, an astigmatic aberration occurs, which becomes an obstacle to obtaining highly detailed images.

In order to prevent the aforementioned problem, the micro lenses 55a of the micro lens array 55 of the image exposure apparatus according to the present embodiment are of shapes different from conventional micro lenses. Hereinafter, this point will be described in detail.

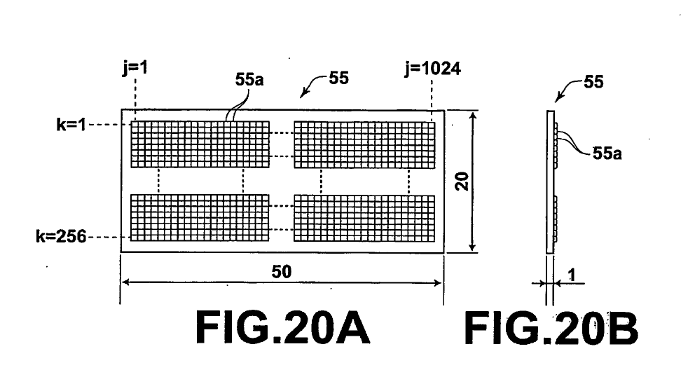

FIG. 20A and FIG. 20B are a front view and a side view of the entire micro lens array 55, respectively. The dimensions of the micro lens array 55 are also illustrated in these figures, in units of mm. In the present embodiment, 256 columns of 1024 micro mirrors 62 of the DMD 50 are driven, as described previously with reference to FIG. 16. The micro lens array 55 comprises 256 columns of horizontal rows each including 1024 micro lenses 55a, corresponding to the micro mirrors 62. Note that in FIG. 20A, the horizontal direction, in which the rows of micro lenses 55a extend, is denoted as j, and the vertical direction is denoted as k.

Each micro lens 55a has different powers in the x direction and the y direction, in order to correct the aforementioned anisotropic distortion of the reflective surface of the micro mirrors 62. That is, each micro lens 55a has a power which is rotationally asymmetric with respect to the optical axis. More specifically, each micro lens 55a in the present embodiment is a cylindrical lens having a power of 0 in the x direction, and a power of a positive value in the y direction. The value of the power in the y direction is determined such that the difference in beam waist position (astigmatic difference) in the x direction and the y direction after the laser beam passes through the lens systems 52 and 54 and the micro lenses 55a approximates 0, taking the curvature of the reflective surface of the micro mirror 62 into consideration.

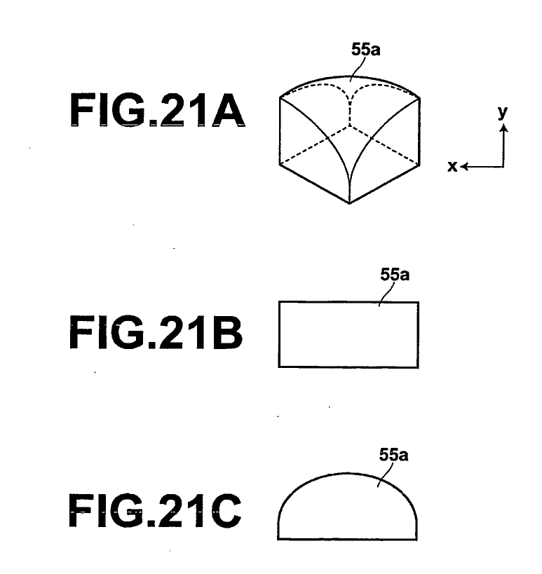

FIG. 21A is a perspective view of an example of such a micro lens 55a. The micro lens 55a has a square bottom surface having diagonals in the x direction and the y direction, and a curved upper surface. As illustrated in FIG. 21B, the micro lens 55a has a rectangular cross section parallel to the x direction that passes through the optical axis. As illustrated in FIG. 21C, the micro lens 55a has a protrusion-shaped cross section, which has a linear bottom and an arcuate top, is parallel to the y direction, and passes through the optical axis.

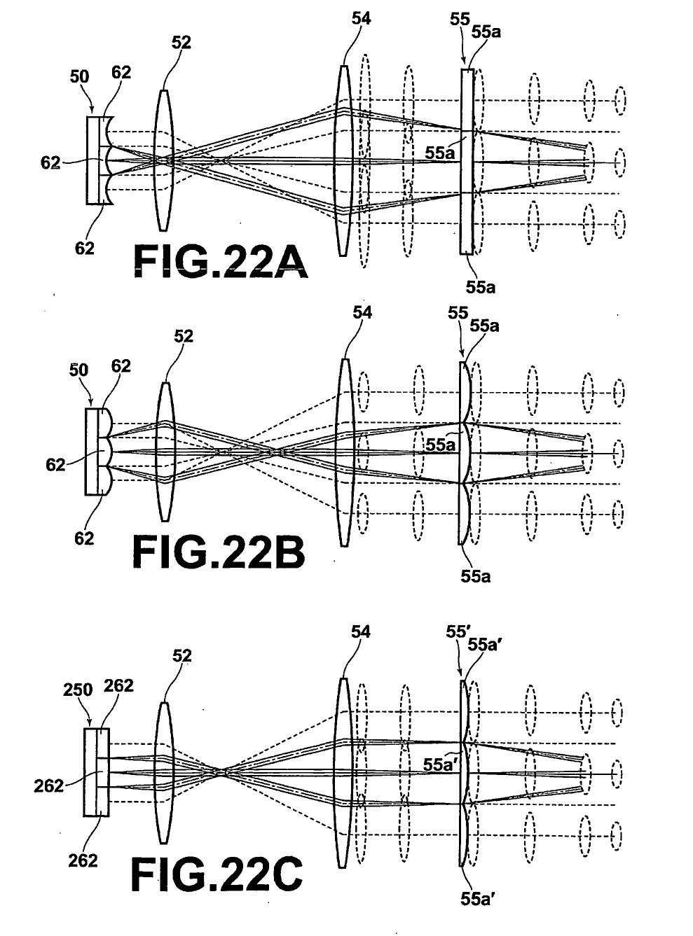

The manner in which aberrations caused by the distortion in the reflective surfaces of the micro mirrors 62 is corrected by the micro lenses 55a will be described in greater detail. FIGS. 22A and 22B are schematic diagrams that illustrate the manner in which the light reflected by the micro mirrors 62 are corrected within cross sections that pass through the optical axis and are parallel to the x direction and the y direction, respectively. The micro lens array 55 is provided in the vicinity of a focusing position, at which the images of the micro mirrors 62 are focused by the first focusing optical system.

Note that the TIR prism 70 is omitted from FIGS. 22A and 22B. Three adjacent micro mirrors 62 are illustrated in FIGS. 22A and 22B, and the light beams reflected by the center and the edges of the central micro mirror 62 are denoted by solid lines. In addition, the manner in which the beam diameters of the beams reflected by the three micro mirrors 62 change as the beams propagate downstream from the lens system 54 is denoted by the ovals illustrated by broken lines.

As illustrated in FIG. 22A, the light, which is reflected by the micro mirror 62 having the concave shape in the x direction, becomes convergent light, and enters the micro lens 55a after passing through the lens systems 52 and 54. As described previously, the power of the micro lens 55a in the x direction is 0. Therefore, the light that enters the micro lens 55a propagates without changing its angle with respect to the optical axis in the x direction, and the beam diameter thereof becomes minimal at its beam waist position.

Meanwhile, as illustrated in FIG. 22B, the light, which is reflected by the micro mirror having the convex shape in the y direction, becomes divergent light, and enters the micro lens 55a after passing through the lens systems 52 and 54. As described previously, the micro lens 55a has a positive power in the y-direction. Therefore, the light that enters the micro lens 55a is condensed in the y direction, and the beam diameter thereof becomes minimal at the same position as the aforementioned beam waist position of the x direction.

As described above, the micro lens 55a is configured to have different powers in the x direction and the y direction, corresponding to the anisotropic shape of the reflective surface of the micro mirror. Thereby, astigmatic aberrations can be corrected, and the cross sectional shape of the beam can be prevented from becoming oval. Accordingly, the beam waist positions in the x direction and the y direction are matched, the cross sectional shape of the beam can be shaped, and a condensed beam can be utilized to form images. Therefore, obtainment of highly detailed images becomes possible.

In the above description, a case has been described in which the reflective surfaces of the micro mirrors 62 are concave in the x direction and convex in the y direction. It is also possible to correct astigmatic aberrations caused by the reflective surfaces of the micro mirrors 62, in the case that the reflective surfaces are planar in one of the x direction and the y direction, and concave or convex in the other. Next, these cases will be described.

First, a case in which a DMD 250 comprising a plurality of micro mirrors 262, of which the reflective surfaces are concave in the x direction and planar in the y direction, is employed to form images will be described. For the sake of simplicity, the concave shape of the micro mirrors 262 in the x direction will be the same as the concave shape of the micro mirrors 62 in the x direction.

In this case, a micro lens array 55, comprising a plurality of micro lenses 55a′ is employed. Each micro lens 55a′ is a cylindrical lens having a power of 0 in the x direction, and a power of a positive value smaller than that of the aforementioned micro lens 55a in the y direction. That is, the micro lens 55a′ has a greater radius of curvature in the y direction than the micro lens 55a. The value of the power in the y direction of the micro lens 55a′ is determined such that the difference in beam waist position (astigmatic difference) in the x direction and the y direction after the laser beam passes through the lens systems 52 and 54 and the micro lenses 55a approximates 0, taking the curvature of the reflective surface of the micro mirror 62 into consideration.

The manner in which aberrations caused by the distortion in the reflective surfaces of the micro mirrors 262 are corrected by the micro lenses 55a′ will be described with reference to FIGS. 22A and 22C. FIG. 22C is a schematic diagram that illustrates the manner in which the light reflected by the micro mirrors 262 is corrected within cross sections that pass through the optical axis and are parallel to the y direction. The format of FIG. 22C is the same as those of FIGS. 22A and 22B. In this case also, the micro lens array 255 is provided in the vicinity of a focusing position, at which the images of the micro mirrors 262 are focused by the first focusing optical system.

With regard to the x direction, the operation of the micro lens 55a′ is the same as that of the micro lens 55a described with reference to FIG. 22A. Therefore, the beam diameter of the light in the x direction becomes minimal at its beam waist position.

Meanwhile, as illustrated in FIG. 22C, the light, which is reflected by the micro mirror having the planar shape in the y direction, enters the micro lens 55a′ after passing through the lens systems 52 and 54 as collimated light. As described previously, the micro lens 55a′ has a positive power in the y direction. Therefore, the light that enters the micro lens 55a′ is condensed in the y direction, and the beam diameter thereof becomes minimal at the same position as the aforementioned beam waist position of the x direction.

In this manner, astigmatic aberrations can be corrected even in cases in which the reflective surfaces of the micro mirrors have a concave shape and a planar shape in different directions within a plane perpendicular to the optical axis, by employing micro lenses corresponding to the shape of the reflective surfaces. Accordingly, similar advantageous effects can be obtained as in the previously described case.

Note that the cross sectional shape of the micro lenses 55a and 55a′ in the y direction is not limited to the flat bottomed protrusion illustrated in FIG. 21C, and may be a meniscus shape. In addition, the power of the micro lenses in the direction that the reflective surfaces of the micro mirrors are concave is 0 in the present embodiment. However, the present invention is not limited to this configuration. The micro lenses may have a positive or negative power in the direction that the reflective surfaces of the micro mirrors are concave, as long as the light becomes convergent after passing through the micro lenses and astigmatic aberrations caused by the micro mirrors can be corrected.

Next, a case will be described in which the reflective surfaces of the micro mirrors are planar in the x direction and convex in the y direction will be described. In this case, micro lenses having positive powers in both the x direction and the y direction, with the power in the x direction being smaller than the power in the y direction, are employed instead of the cylindrical micro lenses 55a and 55a′. A lens configured to have cross sectional shapes equal to spherical lenses having different radii of curvatures in directions parallel to the x direction and the y direction is an example of such a micro lens.

The values of the power in the x direction and the y direction of the micro lenses are determined such that the difference in beam waist position (astigmatic difference) in the x direction and the y direction after the laser beam passes through the lens systems 52 and 54 and the micro lenses approximates 0, taking the curvature of the reflective surface of the micro mirrors into consideration.

In this case, with regard to the x direction, the operation of the micro lenses is the same as that of the micro lenses 55a′ described with reference to FIG. 22C. In addition, with regard to the y direction, the operation of the micro lenses is the same as that of the micro lenses 55a described with reference to FIG. 22B. Accordingly, the beam waist positions in the x direction and the y direction can be matched.

In this manner, astigmatic aberrations can be corrected even in cases in which the reflective surfaces of the micro mirrors have a planar shape and a convex shape in different directions within a plane perpendicular to the optical axis, by employing micro lenses corresponding to the shape and curvature of the reflective surfaces. Accordingly, similar advantageous effects can be obtained as in the previously described cases.

As described above, even if the reflective surfaces of the micro mirrors have different shapes in the x direction and the y direction, astigmatic aberrations caused by the micro mirrors can be corrected by setting the powers of the micro lenses to be different in the x direction and the y direction. Accordingly, highly detailed images can be obtained.

Note that in the above description, the curved shape of the micro lenses is spherical. However, the present invention is not limited to this configuration, and higher order (quartic, sextic, . . . ) aspherical shapes may be adopted.

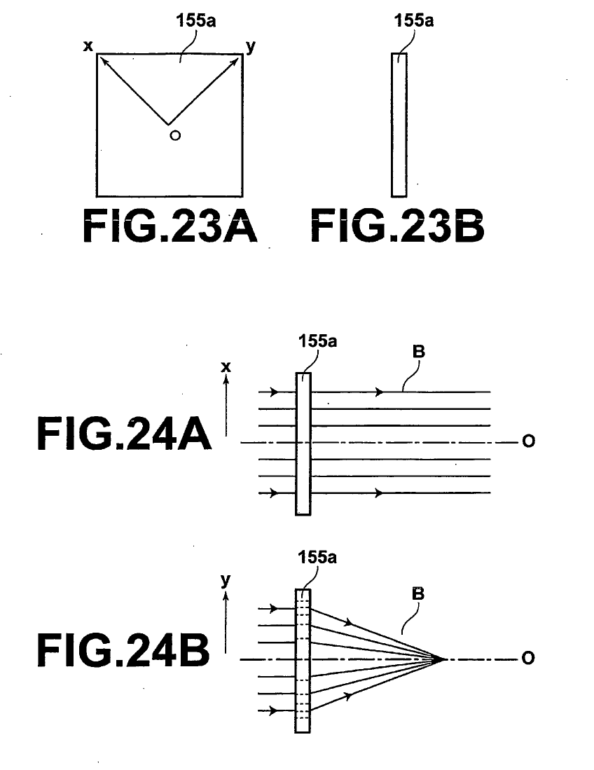

In the embodiments described above, each of the micro lenses that constitute the micro lens arrays are refractive lenses. Similar advantageous effects may be obtained by employing gradient index lenses instead of the refractive lenses. FIG. 23A and FIG. 23B illustrate a micro lens 155a as an example of such a gradient index lens, wherein FIG. 23A is a front view, and FIG. 23B is a side view. As illustrated in FIG. 23A and FIG. 23B, the micro lens 155a is of a parallel plate shape. Note that the x and y directions in FIG. 23A are those as described previously.

FIG. 24A and FIG. 24B schematically illustrate the states of the laser beam B when it passes through the micro lens 155a in cross sections parallel to the x direction and the y direction, respectively. The micro lens 155a has a uniform refractive index distribution in the x direction, and a refractive index distribution that becomes greater toward the exterior from the optical axis O in the y direction. The broken lines within the micro lens 155a illustrated in FIG. 24B denote positions at which the refractive index changes at predetermined pitches from the optical axis O.

As illustrated in FIG. 24A and FIG. 24B, if the cross sections parallel to the x direction and parallel to the y direction are compared, the collimated light that enters the micro lens 155a exits as collimated light in the cross section parallel to the x direction, while the light that enters the micro lens 155a exits as convergent light in the cross section parallel to the y direction. The same advantageous effects as those obtained by employing the micro lens array constituted by the aforementioned micro lenses 55a and 55a′ can be obtained by a micro lens array constituted by the gradient index lenses.

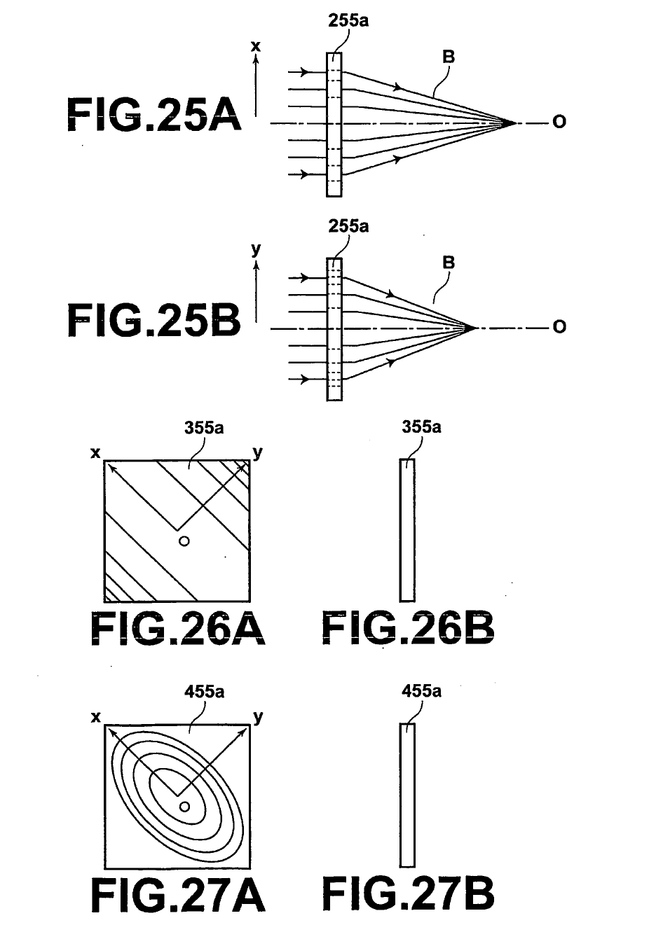

As a further alternative, micro lenses 255a, which have refractive index distributions is both the x direction and the y direction, while the rate of change in refractive index is smaller and the focal distance is longer in the x direction than in the y direction, may be employed. FIG. 25A and FIG. 25B schematically illustrate the condensing states of the laser beam B by the micro lens 255a in cross sections parallel to the x direction and the y direction, respectively. The micro lens 255a has a refractive index distribution that becomes greater toward the exterior from the optical axis O. The broken lines within the micro lens 255a illustrated in FIG. 25A and FIG. 25B denote positions at which the refractive index changes at predetermined pitches from the optical axis O.

As illustrated in FIG. 25A and FIG. 25B, if the cross sections parallel to the x direction and parallel to the y direction are compared, the rate of change of the refractive index is greater in the y direction of the micro lens 255a, and the focal distance is shorter. The same advantageous effects as those obtained by employing the micro lens array constituted by the aforementioned micro lenses that have positive powers in both the x direction and the y direction, with a smaller power in the x direction, can be obtained by a micro lens array constituted by the gradient index lenses 255a.

Further, diffraction lenses may be employed instead of the aforementioned refractive lenses and the gradient index lenses. FIG. 26A and FIG. 26B illustrate a micro lens 355a, as an example of such a diffraction lens. FIGS. 26A and 26B are front and side views of the micro lens 355a, respectively. As illustrated in FIG. 26A and FIG. 26B, the micro lens 355a is of a parallel plate shape. Note that the x and y directions in FIG. 26A are those as described previously. As schematically illustrated in FIG. 26A, the micro lens 355a has a diffraction grating formed therein at predetermined pitches. The micro lens 355a has a power of 0 in the x direction, and a positive power in the y direction. The same advantageous effects as those obtained by employing micro lens arrays constituted by the aforementioned micro lenses 55a or the micro lenses 55a′ can be obtained by a micro lens array constituted by the diffraction lenses 355a.

In addition, a diffraction lens 455a as illustrated in FIGS. 27A and 27B may be employed instead of the aforementioned lens having positive powers in both the x direction and the y direction, with the power in the x direction being smaller than that in the y direction. FIGS. 27A and 27B are a front view and a side view of the micro lens 455a, respectively. As illustrated in FIGS. 27A and 27B, the diffraction lens 455a is of a parallel plate shape. Note that the x and y directions in FIG. 27A are those as described previously. As schematically illustrated in FIG. 27A, the diffraction grating of the micro lens 455a has a greater pitch spacing in the y direction than in the x direction, and the power in the x direction is configured to be smaller than the power in the y direction. The same advantageous effects as those obtained by employing micro lens arrays constituted by the aforementioned micro lenses having positive powers in both the x direction and the y direction, with the power in the x direction being smaller than that in the y direction, can be obtained by a micro lens array constituted by the diffraction lenses 455a.

Further, combinations of at least two of: refractive lenses; gradient index lenses; and diffraction lenses may be employed instead of the aforementioned micro lenses. A Fresnel lens is an example of a combination of a refractive lens and a diffraction lens. As another example, a spherical lens having a refractive index distribution is a combination of a refractive lens and a gradient index lens. In the case that this type of lens is employed, the surface shape and the refractive index distribution both correct aberrations due to distortions of the reflective surfaces of the micro mirrors.

Here, separated condensing positions will be described with reference to FIG. 22A. The light beams reflected by each micro mirror 62 spread and overlap upstream of the micro lenses 55a, as schematically illustrated by the overlapping ovals denoted by broken lines in FIG. 22A. In contrast, the light beams reflected by adjacent micro mirror 62 are condensed as separate light beams downstream of the micro lenses 55a, as schematically illustrated by the separated ovals denoted by broken lines in FIG. 22A. In FIG. 22B as well, the light beams reflected by each micro mirror 62 are condensed as separate light beams downstream of the micro lenses 55a.

That is, a predetermined range downstream of the micro lenses 55a includes separated condensing positions, at which the light beams reflected by each micro mirror 62 are condensed as separate light beams by the lens systems 52, 54, and the micro lenses 55a.

In the present embodiment, the aperture array 59 is provided at a separated condensing position within the range. The aperture array 59 is configured such that each aperture 59a thereof only transmits light beams that propagate thereto via a corresponding micro lens 55a. Thereby, entry of light beams which have been condensed by adjacent micro lenses 55a that do not correspond to the apertures 59a, and entry of stray light beams can be prevented, thereby improving the extinction ratio of the image exposure apparatus. In addition, the aperture array 59 configured in this manner exhibits high light utilization efficiency, and may also function to shape the cross sectional shapes of the light beams with the apertures 59a.

Hereinafter, image exposure apparatuses according to other embodiments of the present invention will be described. In the following descriptions and the drawings referenced thereby, only characteristic structures and differences between previous embodiments will be described in detail. Elements which are the same as those of previous embodiments will be denoted with the same reference numbers, and descriptions thereof will be omitted, insofar as they are not particularly necessary.

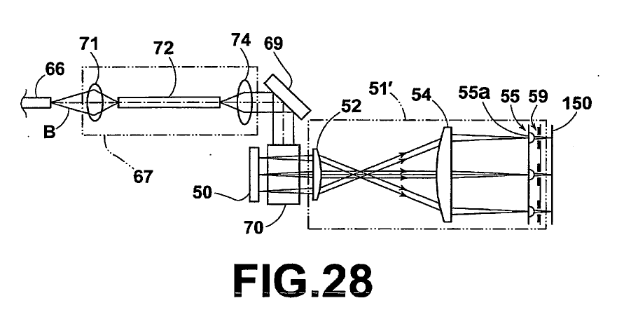

An image exposure apparatus according to a second embodiment of the present invention will be described next. FIG. 28 is a schematic sectional view that illustrates an exposure head of the image exposure apparatus according to the second embodiment of the present invention. The exposure head of FIG. 28 differs from the exposure head of the image exposure apparatus according to the first embodiment illustrated in FIG. 5 in that it comprises a focusing optical system 51′ instead of the focusing optical system 51. The focusing optical system 51′ differs from the focusing optical system 51 in that the second focusing optical system, comprising the lens systems 57 and 58, has been omitted. The other structures are the same as those of the previously described embodiment, and therefore detailed descriptions thereof will be omitted.

That is, in the second embodiment, light beams, which are condensed by the micro lens array 55, directly expose the photosensitive material 150. The second embodiment is capable of obtaining the same advantageous effects as the first embodiment.

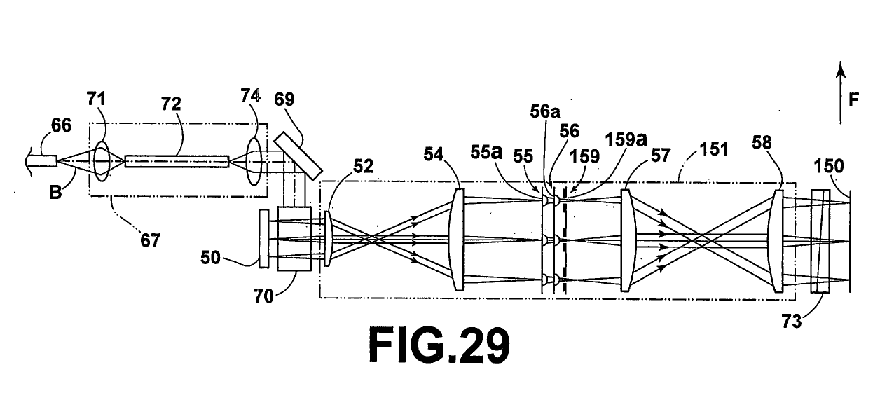

An image exposure apparatus according to a third embodiment of the present invention will be described next. FIG. 29 is a schematic sectional view that illustrates an exposure head of the image exposure apparatus according to the third embodiment of the present invention. The exposure head of FIG. 29 differs from the exposure head of the image exposure apparatus according to the first embodiment illustrated in FIG. 5 in that it further comprises a micro lens array 56 at a separated condensing position. The image exposure apparatus according to the third embodiment employs a focusing optical system 151 instead of the focusing optical system 51 of the first embodiment. The focusing optical system 151 comprises: the first focusing optical system comprising lens systems 52 and 54; the second focusing optical system comprising the lens systems 57 and 58; the micro lens array 55; the condensing micro lens array 56; and an aperture array 159. The micro lens array 55, the condensing micro lens array 56, and the aperture array 159 are provided between the first and second focusing optical systems. The other structures are the same as those of the previously described embodiment, and therefore detailed descriptions thereof will be omitted.

The condensing micro lens array 56 comprises a plurality of micro lenses 56a that individually condense the light beams from each pixel portion. Light beams, of which the aberration has been corrected by the micro lenses 55a of the micro lens array 55, enter the micro lenses 56a. In addition, the aperture array 159 has a great number of apertures 159a, corresponding to the micro lenses 56a of the micro lens array 56, formed in a light shielding member, similar to the aperture array 59. The aperture array 159 is provided such that only light beams that propagate through the corresponding micro lens 56a enter each aperture 159a.

The third embodiment is capable of obtaining the same advantageous effects as the first embodiment. In addition, in the configuration described above, the light beams, which have been condensed and of which the cross sectional shapes have been shaped by the micro lens array 55, are further condensed by the micro lens array 56. Therefore, the beam spot size can be controlled to be even smaller than in the first embodiment, improving the sharpness of images to be exposed.

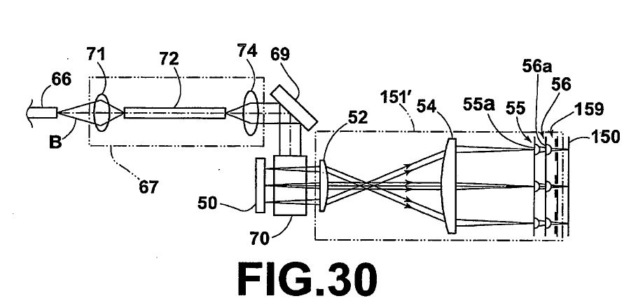

An image exposure apparatus according to a fourth embodiment of the present invention will be described next. FIG. 30 is a schematic sectional view that illustrates an exposure head of the image exposure apparatus according to the fourth embodiment of the present invention. The exposure head of FIG. 30 differs from the exposure head of the image exposure apparatus according to the third embodiment illustrated in FIG. 29 in that it comprises a focusing optical system 151′ instead of the focusing optical system 151. The focusing optical system 151′ differs from the focusing optical system 151 in that the second focusing optical system, comprising the lens systems 57 and 58, has been omitted. The other structures are the same as those of the previously described embodiment, and therefore detailed descriptions thereof will be omitted.

That is, in the fourth embodiment, light beams, which are condensed by the micro lens array 55 and the micro lens array 56, directly expose the photosensitive material 150. The fourth embodiment is capable of obtaining the same advantageous effects as the third embodiment.

Further, the condensing micro lens array 56 may be provided to be movable in the direction of the optical axes of the light beams. In this case, adjustments to the focal point of the light beams are facilitated. Particularly, because the condensing micro lens array 56 is provided at the separated condensing position and not at the focusing position, the variance in light utilization efficiency can be suppressed to a minimum when the focal point is adjusted. That is, the variance in light utilization efficiency at the separated condensing position and the vicinity thereof is smaller than that at the focusing position and the vicinity thereof. Therefore, drastic changes in the light utilization efficiency when the condensing micro lens array 56 is moved in the direction of the optical axes can be prevented.

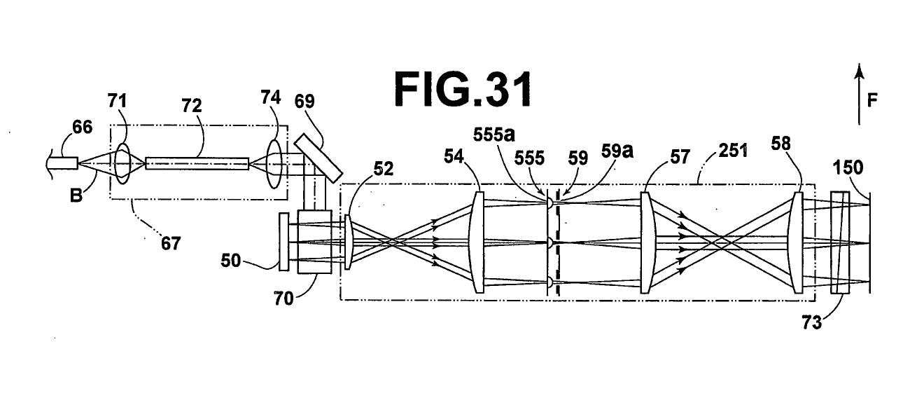

An image exposure apparatus according to a fifth embodiment of the present invention will be described next. FIG. 31 is a schematic sectional view that illustrates an exposure head of the image exposure apparatus according to the fifth embodiment of the present invention. The exposure head of FIG. 31 differs from the exposure head of the image exposure apparatus according to the first embodiment illustrated in FIG. 5 in that it employs a focusing optical system 251 instead of the focusing optical system 51. The characteristic features of the image exposure apparatus according to the fifth embodiment are that: micro mirrors have powers of different signs in two directions within a plane perpendicular to the optical axis; a micro lens array 555 is provided at a separated condensing position; and each micro lens 555a of the micro lens array 555 has powers of different signs in two directions within a plane perpendicular to the optical axis, to correct aberrations caused by the powers of the micro mirrors.

The shapes of the micro mirrors 62 of the image exposure apparatus according to the fifth embodiment are the same as those of the first embodiment, as illustrated in FIG. 18A and FIG. 18B. Note that FIG. 18A and FIG. 18B are graphs that schematically illustrate the height displacement of the reflective surface of a micro mirror 62 in planes parallel to the x direction and the y direction, respectively. In addition, the x and y directions are the same as those of the first embodiment, illustrated in FIG. 17. As illustrated in FIG. 18A and FIG. 18B, the reflective surface of the micro mirror 62 is a curved surface having a concave shape in the x direction and a convex shape in they direction. That is, the reflective surface is a rotationally asymmetrical curved surface, and has an anisotropic distortion. Due to this shape, the micro mirror 62 is of a rotationally asymmetrical structure that has powers of different signs in the x direction and the y direction.

If collimated light is irradiated onto the micro mirror 62 having the powers of different signs as described above, the reflected light will be convergent in the x direction and divergent in the y direction, as described previously with reference to FIG. 19A and FIG. 19B.

In the case that light that converges in the x direction and diverges in the y direction as described above is condensed by a normal lens, which has a power rotationally symmetrical with respect to the optical axis, the position in the direction of the optical axis at which the beam diameter is minimal (beam waist position) is different in the x direction and the y direction. That is, an astigmatic aberration occurs, which becomes an obstacle to obtaining highly detailed images.

In order to prevent the aforementioned problem, the micro lenses 555a of the micro lens array 555 of the image exposure apparatus according to the present embodiment are of shapes different from conventional micro lenses. Hereinafter, this point will be described in detail.

The structure of the micro lens array 555 as a whole is the same as that of the first embodiment illustrated in FIG. 20A and FIG. 20B, and therefore a detailed description thereof will be omitted.

Each micro lens 555a has different powers in the x direction and the y direction, in order to correct the aforementioned anisotropic distortion of the reflective surface of the micro mirrors 62. That is, each micro lens 555a has a power which is rotationally asymmetric with respect to the optical axis. More specifically, each micro lens 555a of the fifth embodiment is a cylindrical lens having a power of 0 in the x direction, and a power of a positive value in the y direction, similar to the cylindrical lens of the first embodiment described with reference to FIGS. 21A, 21B, and 21C. The value of the power in the y direction is determined such that the difference in beam waist position (astigmatic difference) in the x direction and the y direction after the laser beam passes through the lens systems 52 and 54 and the micro lenses 555a approximates 0, taking the curvature of the reflective surface of the micro mirror 62 into consideration.

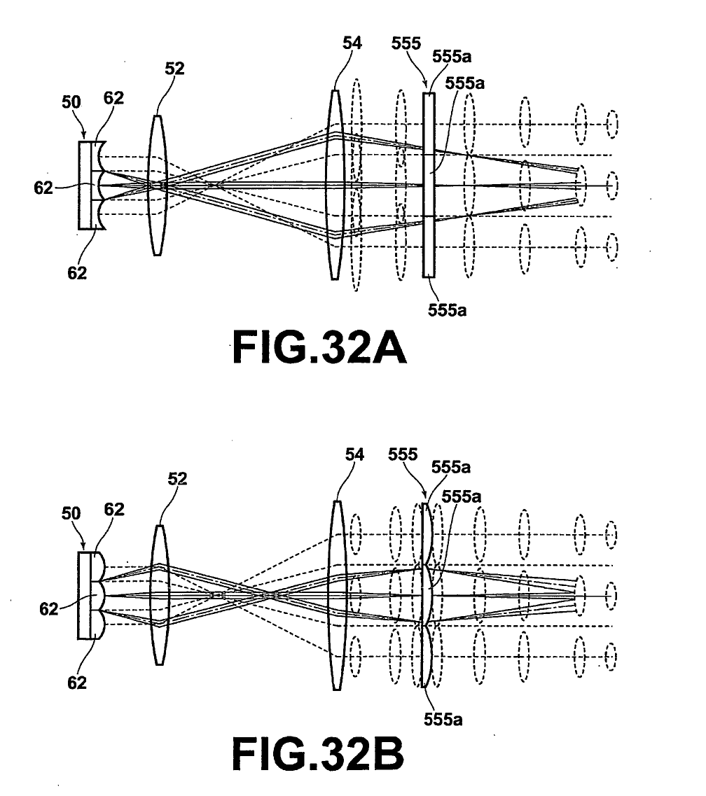

The manner in which aberrations caused by the distortion in the reflective surfaces of the micro mirrors 62 is corrected by the micro lenses 555a will be described in greater detail. FIGS. 32A and 32B are schematic diagrams that illustrate the manner in which the light reflected by the micro mirrors 62 are corrected within cross sections that pass through the optical axis and are parallel to the x direction and the y direction, respectively.

Note that the TIR prism 70 is omitted from FIGS. 32A and 32B. Three adjacent micro mirrors 62 are illustrated in FIGS. 32A and 32B, and the light beams reflected by the center and the edges of the central micro mirror 62 are denoted by solid lines. In addition, the manner in which the beam diameters of the beams reflected by the three micro mirrors 62 change as the beams propagate downstream from the lens system 54 is denoted by the ovals illustrated by broken lines.

Here, the effects of correction by the micro lenses 555a of the fifth embodiment become clear, by comparing FIGS. 19A and 19B against FIGS. 32A and 32B. In FIG. 19B, the light beams spread and overlap in the y direction downstream of the focusing position of the micro mirrors 62, as schematically illustrated by the overlapping ovals denoted by broken lines. In contrast, the light beams are condensed as separate light beams upstream of the focusing position of the micro mirrors 62, as schematically illustrated by the separated ovals denoted by broken lines in FIG. 19B. As illustrated in FIG. 32B, the micro lens array 555 is provided at the separated condensing position.

As illustrated in FIG. 32A, the light, which is reflected by the micro mirror 62 having the concave shape, becomes convergent light, and enters the micro lens 555a after passing through the lens systems 52 and 54. As described previously, the power of the micro lens 555a in the x direction is 0. Therefore, the light that enters the micro lens 555a propagates without changing its angle with respect to the optical axis in the x direction, and the beam diameter thereof becomes minimal at its beam waist position.

Meanwhile, as illustrated in FIG. 32B, the light, which is reflected by the micro mirror having the convex shape in the y direction, becomes divergent light, and enters the micro lens 555a after passing through the lens systems 52 and 54. As described previously, the micro lens 555a has a positive power in the y-direction. Therefore, the light that enters the micro lens 555a is condensed in the y direction, and the beam diameter thereof becomes minimal at the same position as the aforementioned beam waist position of the x direction.

As described above, the micro lens 555a is configured to have different powers in the x direction and the y direction. Thereby, astigmatic aberrations can be corrected, and the cross sectional shape of the beam can be prevented from becoming oval, even if the reflective surface of the micro mirror 62 has powers of different signs in two directions within a plane perpendicular to the optical axis. Accordingly, the beam waist positions in the x direction and the y direction are matched, the cross sectional shape of the beam can be shaped, and a condensed beam can be utilized to form images. Therefore, obtainment of highly detailed images becomes possible.

Note that the cross sectional shape of the micro lenses 555a in the y direction is not limited to the flat bottomed protrusion illustrated in FIG. 21C, and may be a meniscus shape. In addition, the power of the micro lenses in the direction that the reflective surfaces of the micro mirrors are concave is 0 in the present embodiment. However, the present invention is not limited to this configuration. The micro lenses may have a positive or negative power in the direction that the reflective surfaces of the micro mirrors are concave, as long as the light becomes convergent after passing through the micro lenses and astigmatic aberrations caused by the micro mirrors can be corrected. In addition, in the above description, the curved shape of the micro lenses is spherical. However, the present invention is not limited to this configuration, and higher order (quartic, sextic, . . . ) aspherical shapes may be adopted.

The micro lenses 555a of the micro lens array 555 of the fifth embodiment were described as refractive lenses. Alternatively, the gradient index lenses illustrated in FIGS. 23A, 23B, 24A, and 24B, the diffraction lens illustrated in FIGS. 26A and 26B, or combined lenses may be employed, to obtain the same advantageous effects as those obtained by the aforementioned micro lenses 555a.

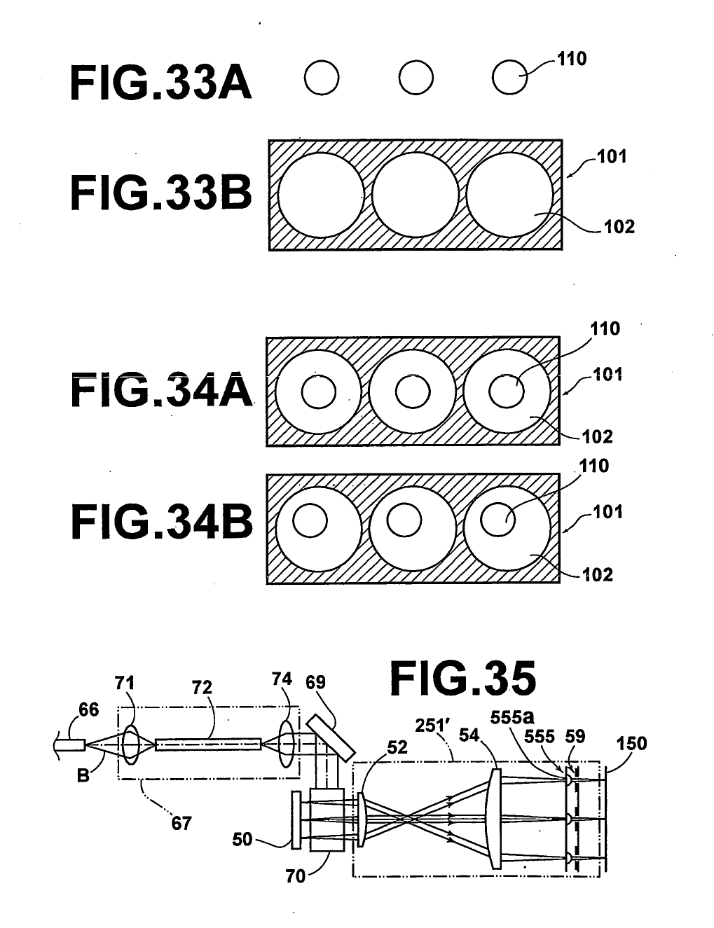

Here, the manner in which reductions in light utilization efficiency and extinction ratio of the image exposure apparatus can be prevented in the case that the micro lens array is provided at the separated condensing position will be described with reference to FIGS. 33A, 33B, 34A, and 34B.

The circular regions denoted by reference number 110 in FIG. 33A are beam spots which have been reflected by the micro mirrors 62 and have passed through the first optical system comprising the lens systems 52 and 54. The rectangular region denoted by reference number 101 in FIG. 33B illustrates a micro lens array 101, in which a plurality of micro lenses 102 are provided.

The micro lenses 102 and the micro lens array 101 are equivalent to the aforementioned micro lenses 555a and the micro lens array 555. The micro lens array 101 is provided at a separated condensing position.

The aforementioned beam spots differ from images of pixel portions in that they are beam spots of small sizes (condensed sizes). The relationship between these beam spots and the micro lenses 102 of the micro lens array 101 is as illustrated in FIGS. 34A and 34B. That is, eclipsing of the beam spots and entrance of the beam spots into micro lenses 102 adjacent to those that they are intended to enter are prevented, even if the spatial light modulating element and the condensing micro lens array are shifted somewhat, as illustrated in FIG. 34B, as well as in cases that the beam spot and the micro lens 102 are concentric, as illustrated in FIG. 34A. Accordingly, reductions in the light utilization efficiency and extinction ratio of the image exposure apparatus are prevented.

In the fifth embodiment, the aperture array 59 is provided at the separated condensing position. The aperture array 59 is configured such that only light which has passed through a corresponding micro lens 555a enters each aperture 59a thereof. Thereby, entry of light beams which have been condensed by adjacent micro lenses 555a that do not correspond to the apertures 59a, and entry of stray light beams can be prevented, thereby improving the extinction ratio of the image exposure apparatus. In addition, the aperture array 59 configured in this manner exhibits high light utilization efficiency, and may also function to shape the cross section shapes of the light beams with the apertures 59a.

An image exposure apparatus according to a sixth embodiment of the present invention will be described next. FIG. 35 is a schematic sectional view that illustrates an exposure head of the image exposure apparatus according to the sixth embodiment of the present invention. The exposure head of FIG. 35 differs from the exposure head of the image exposure apparatus according to the fifth embodiment illustrated in FIG. 31 in that it comprises a focusing optical system 251′ instead of the focusing optical system 251. The focusing optical system 251′ differs from the focusing optical system 251 in that the second focusing optical system, comprising the lens systems 57 and 58, has been omitted. That is, in the second embodiment, light beams, which are condensed by the micro lens array 555, directly expose the photosensitive material 150. The sixth embodiment is capable of obtaining the same advantageous effects as the fifth embodiment.

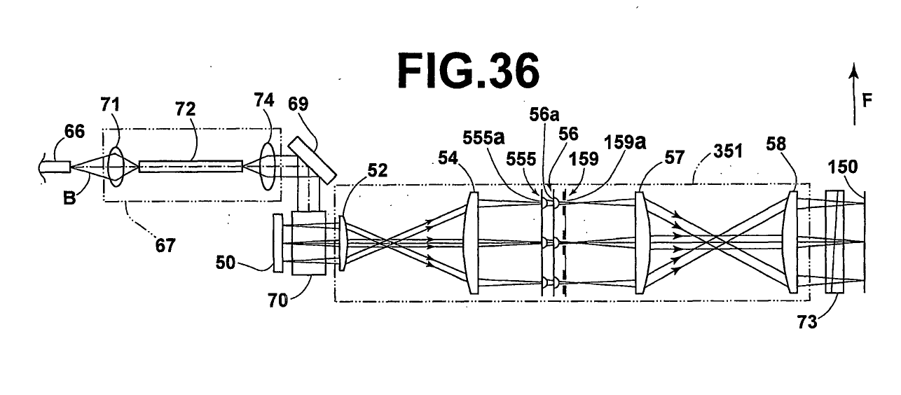

An image exposure apparatus according to a seventh embodiment of the present invention will be described next. FIG. 36 is a schematic sectional view that illustrates an exposure head of the image exposure apparatus according to the seventh embodiment of the present invention. The exposure head of FIG. 36 differs from the exposure head of the image exposure apparatus according to the fifth embodiment illustrated in FIG. 31 in that it further comprises a micro lens array 56 at a separated condensing position. The image exposure apparatus according to the seventh embodiment employs a focusing optical system 351 instead of the focusing optical system 251 of the fifth embodiment. The focusing optical system 351 comprises: the first focusing optical system comprising lens systems 52 and 54; the second focusing optical system comprising the lens systems 57 and 58; the micro lens array 555; the condensing micro lens array 56; and an aperture array 159. The micro lens array 555, the condensing micro lens array 56, and the aperture array 159 are provided between the first and second focusing optical systems. The other structures are the same as those of the previously described embodiment, and therefore detailed descriptions thereof will be omitted.

The condensing micro lens array 56 comprises a plurality of micro lenses 56a that individually condense the light beams from each pixel portion. Light beams, of which the aberration has been corrected by the micro lenses 555a of the micro lens array 555, enter the micro lenses 56a. In addition, the aperture array 159 has a great number of apertures 159a, corresponding to the micro lenses 56a of the micro lens array 56, formed in a light shielding member, similar to the aperture array 59. The aperture array 159 is provided such that only light beams that propagate through the corresponding micro lens 56a enter each aperture 159a.

The seventh embodiment is capable of obtaining the same advantageous effects as the fifth embodiment. In addition, in the configuration described above, the light beams, which have been condensed and of which the cross sectional shapes have been shaped by the micro lens array 55, are further condensed by the micro lens array 56. Therefore, the beam spot size can be controlled to be even smaller than in the fifth embodiment, improving the sharpness of images to be exposed.

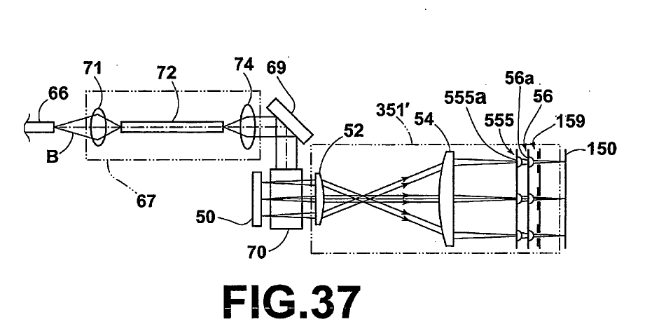

An image exposure apparatus according to an eighth embodiment of the present invention will be described next. FIG. 37 is a schematic sectional view that illustrates an exposure head of the image exposure apparatus according to the eighth embodiment of the present invention. The exposure head of FIG. 37 differs from the exposure head of the image exposure apparatus according to the seventh embodiment illustrated in FIG. 36 in that it comprises a focusing optical system 351′ instead of the focusing optical system 351. The focusing optical system 351′ differs from the focusing optical system 351 in that the second focusing optical system, comprising the lens systems 57 and 58, has been omitted. That is, in the eighth embodiment, light beams, which are condensed by the micro lens array 555 and the micro lens array 56, directly expose the photosensitive material 150. The eighth embodiment is capable of obtaining the same advantageous effects as the seventh embodiment.

Further, the condensing micro lens array 56 may be provided to be movable in the direction of the optical axes of the light beams. In this case, adjustments to the focal point of the light beams are facilitated. Particularly, because the condensing micro lens array 56 is provided at the separated condensing position and not at the focusing position, the variance in light utilization efficiency can be suppressed to a minimum when the focal point is adjusted. That is, the variance in light utilization efficiency at the separated condensing position and the vicinity thereof is smaller than that at the focusing position and the vicinity thereof. Therefore, drastic changes in the light utilization efficiency when the condensing micro lens array 56 is moved in the direction of the optical axes can be prevented.

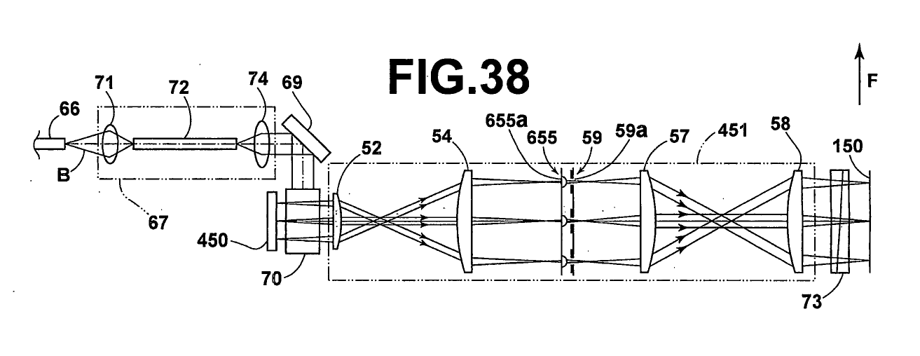

An image exposure apparatus according to a ninth embodiment of the present invention will be described next. FIG. 38 is a sectional view that illustrates an exposure head of the image exposure apparatus according to the ninth embodiment of the present invention. The exposure head of FIG. 38 differs from the exposure head of the image exposure apparatus according to the first embodiment illustrated in FIG. 5 in that it employs a DMD 450 and a focusing optical system 451 instead of the DMD 50 and the focusing optical system 51. The characteristic features of the image exposure apparatus according to the fifth embodiment are that: micro mirrors 462 have different powers of the same sign in two directions within a plane perpendicular to the optical axis; a micro lens array 655 is provided at a separated condensing position; and each micro lens 655a of the micro lens array 555 has different powers in two directions within a plane perpendicular to the optical axis, to correct aberrations caused by the powers of the micro mirrors.

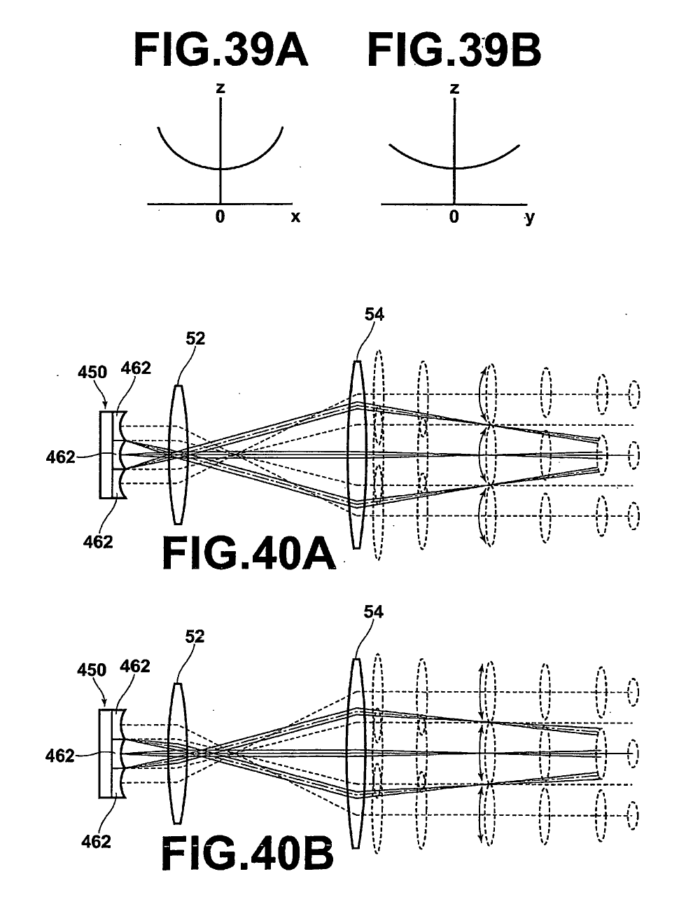

The shapes of the micro mirrors 462 of the image exposure apparatus according to the ninth embodiment are illustrated in FIG. 39A and FIG. 39B. FIG. 39A and FIG. 39B are graphs that schematically illustrate the height displacement of the reflective surface of a micro mirror 462 in planes parallel to the x direction and the y direction, respectively. In addition, the x and y directions are the same as those of the first embodiment, illustrated in FIG. 17. In FIG. 39A and FIG. 39B, the horizontal axes of the graphs represent distances from the center of the reflective surface in the respective directions, and the vertical axes represent displacement in the direction of the optical axis. As illustrated in FIG. 39A and FIG. 39B, the reflective surface of the micro mirror 462 is a convex curved surface in both the x direction and the y direction. However, the radius of curvature is smaller in the x direction than in the y direction, and the reflective surface has an anisotropic distortion. Due to this shape, the micro mirror 462 is of a rotationally asymmetrical structure that has positive powers of in both the x direction and the y direction, with the power in the x direction being greater than that in the y direction.

If collimated light is irradiated onto the micro mirror 462 having the different powers as described above, the reflected light will be convergent in both the x direction and the y direction. However the manner of convergence will differ in the x direction and the y direction.

FIG. 40A and FIG. 40B are diagrams that illustrate how light reflected by the aforementioned micro mirror 462 propagates through the lens systems 52 and 54 that constitute the first focusing system, within planes parallel to the x direction and the y-direction, respectively.

Note that the TIR prism 70 and the micro lens array 655 are omitted from FIG. 40A and FIG. 40B. Three adjacent micro mirrors 462 are illustrated in FIG. 40A and FIG. 40B. The images borne by the light reflected by each of the micro mirrors 462 are denoted by the curved arrows, and the light beams reflected by the center and the edges of the central micro mirror 462 are denoted by solid lines. In addition, the manner in which the beam diameters of the beams reflected by the three micro mirrors 462 change as the beams propagate downstream from the lens system 54 is denoted by the ovals illustrated by broken lines in FIG. 40A and FIG. 40B.

As illustrated in FIG. 40A and FIG. 40B, the light beam reflected by the micro mirrors 462 is condensed to a greater degree in the x direction than in the y direction, and the beam waist position in the x direction is closer to the lens system 54 than the beam waist position in the y direction. In the case that this light beam is condensed by a normal lens, which has a power rotationally symmetrical with respect to the optical axis, the beam waist position will be different in the x direction and the y direction. That is, an astigmatic aberration occurs, which becomes an obstacle to obtaining highly detailed images.

In order to prevent the aforementioned problem, the micro lenses 655a of the micro lens array 655 of the image exposure apparatus according to the ninth embodiment are of shapes different from conventional micro lenses. Hereinafter, this point will be described in detail.

The structure of the micro lens array 655 as a whole is the same as that of the first embodiment illustrated in FIG. 20A and FIG. 20B, and therefore a detailed description thereof will be omitted. Each micro lens 655a has different powers in the x direction and the y direction, in order to correct aberrations due to the aforementioned anisotropic distortion of the reflective surface of the micro mirrors 462. That is, each micro lens 655a is an anamorphic lens having rotationally asymmetrical powers with respect to the optical axis. Cylindrical lenses and toric lenses are examples of anamorphic lenses.

In the ninth embodiment, each micro lens 655a is a cylindrical lens having a power of 0 in the x direction, and a power of a positive value in the y direction, similar to the cylindrical lens of the first embodiment described with reference to FIGS. 21A, 21B, and 21C. The value of the power in the y direction is determined such that the difference in beam waist position (astigmatic difference) in the x direction and the y direction after the laser beam passes through the lens systems 52 and 54 and the micro lenses 555a approximates 0, taking the curvature of the reflective surface of the micro mirror 62 into consideration.

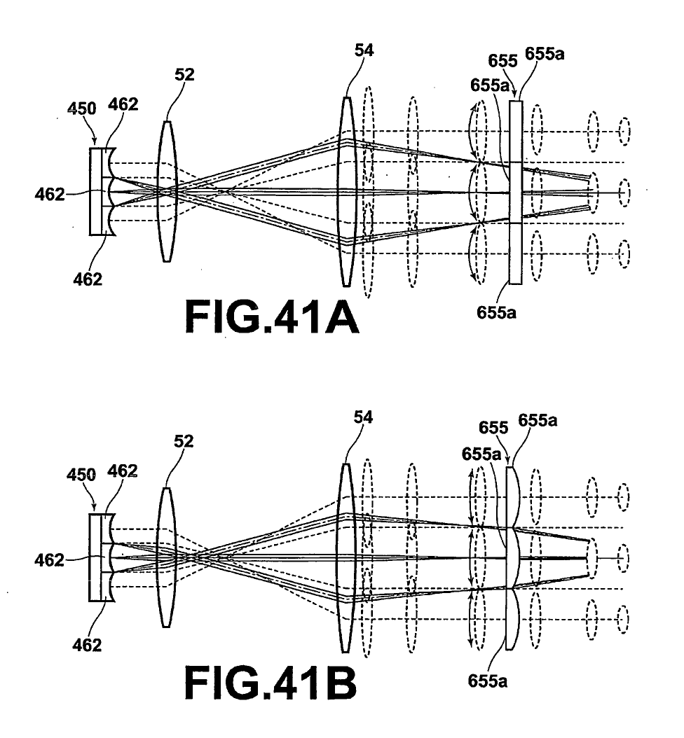

The manner in which aberrations caused by the distortion in the reflective surfaces of the micro mirrors 462 is corrected by the micro lenses 655a will be described in greater detail. FIGS. 41A and 41B are schematic diagrams that illustrate the manner in which the light reflected by the micro mirrors 462 are corrected within cross sections that pass through the optical axis and are parallel to the x direction and the y direction, respectively.

Note that the TIR prism 70 is omitted from FIGS. 41A and 41B. Three adjacent micro mirrors 462 are illustrated in FIGS. 41A and 41B. The images borne by the light reflected by each of the micro mirrors 462 are denoted by the curved arrows, and the light beams reflected by the center and the edges of the central micro mirror 462 are denoted by solid lines. In addition, the manner in which the beam diameters of the beams reflected by the three micro mirrors 462 change as the beams propagate downstream from the lens system 54 is denoted by the ovals illustrated by broken lines.

In FIG. 41A and FIG. 41B, the light beams overlap upstream of the focusing position of the micro mirrors 462, as schematically illustrated by the overlapping ovals denoted by broken lines. In contrast, the light beams are condensed as separate light beams within a predetermined range downstream of the focusing position of the micro mirrors 462, as schematically illustrated by the separated ovals denoted by broken lines in FIG. 41A and FIG. 41B. The micro lens array 655 is provided at a separated condensing position within the predetermined range.

As illustrated in FIG. 41A, the light, which is reflected by the micro mirror 462 having the concave shape, becomes convergent light, and enters the micro lens 655a after passing through the lens systems 52 and 54. As described previously, the power of the micro lens 655a in the x direction is 0. Therefore, the light that enters the micro lens 655a propagates without changing its angle with respect to the optical axis in the x direction, and the beam diameter thereof becomes minimal at its beam waist position.

Meanwhile, as illustrated in FIG. 41B, the light, which is reflected by the micro mirror 462 having the concave shape with a greater radius of curvature in the y direction, becomes convergent light, and enters the micro lens 655a after passing through the lens systems 52 and 54. However, the angle formed by the light beam with respect to the optical axis is smaller than that in the x direction. As described previously, the micro lens 655a has a positive power in the y direction. Therefore, the light that enters the micro lens 655a is condensed in the y direction, and the beam diameter thereof becomes minimal at the same position as the aforementioned beam waist position of the x direction.

As described above, the micro lens 555a is configured to have different powers in the x direction and the y direction. Thereby, astigmatic aberrations can be corrected, and the cross sectional shape of the beam can be prevented from becoming oval, even if the reflective surface of the micro mirror 462 has different powers in two directions within a plane perpendicular to the optical axis. Accordingly, the beam waist positions in the x direction and the y direction are matched, the cross sectional shape of the beam can be shaped, and a condensed beam can be utilized to form images. Therefore, obtainment of highly detailed images becomes possible.

In the above embodiment, an example was described in which the reflective surface of the micro mirror 462 had positive powers in both the x direction and the y direction. It is possible to correct astigmatic aberrations in the case that a micro mirror has different negative powers in the x direction and the y direction, by employing an anamorphic micro lens in a similar manner. This case will be described next.

An example will be described in which a DMD 550, comprising micro mirrors 562 having anisotropic distortions is employed to form images. The micro mirrors 562 is of a convex shape in both the x direction and the y direction, wherein the radius of curvature is greater in the x direction than in the y direction. Due to the shape of the micro mirrors 562, a micro mirror 562 is of a rotationally asymmetric shape having negative powers in both the x direction and the y direction, wherein the absolute value of the power in the x direction is less than the absolute value of the power in the y direction.

In this case, a micro lens array 755 comprising a plurality of micro lenses 755a is employed instead of the micro lens array 655 comprising the micro lenses 655a. Each of the micro lenses 755a has positive powers in both the x direction and the y direction, wherein the power in the x direction is smaller than the power in the y direction.

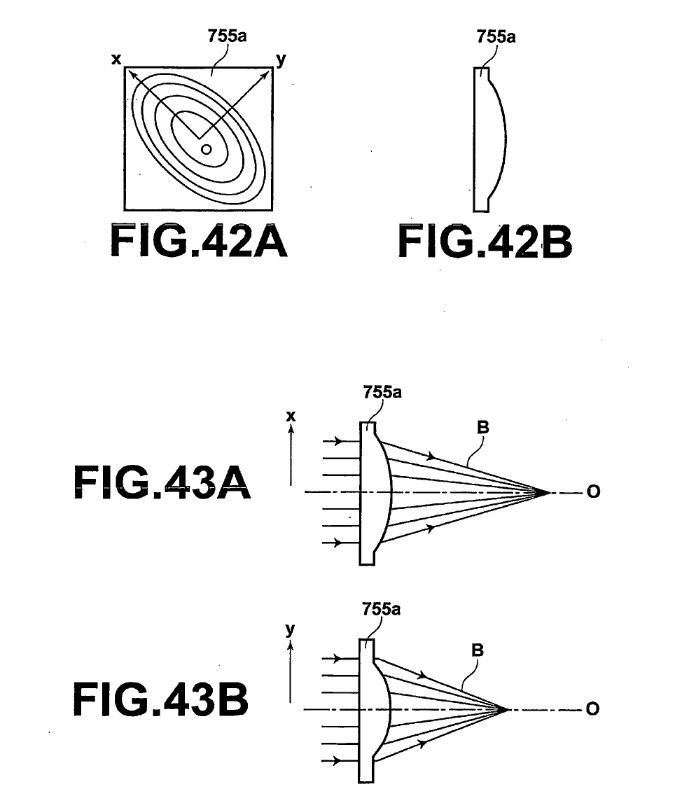

FIG. 42A and FIG. 42B are a front view and a side view of a toric lens that has powers as described above. Note that contour lines of the micro lens 755a are illustrated in FIG. 42A. FIG. 43A and FIG. 43B schematically illustrate the states of the collimated laser beam B when it passes through the micro lens 755a in cross sections parallel to the x direction and the y direction, respectively. That is, when the cross section parallel to the x direction and the cross section parallel to the y direction are compared, the radius of curvature of the micro lens 755a is smaller in the y direction, which results in a shorter focal distance.

More specifically, the values of the power in the x and y directions are determined such that the difference in beam waist position (astigmatic difference) in the x direction and the y direction after the laser beam is reflected by the micro mirror 562 and passes through the lens systems 52 and 54 and the micro lenses 755a approximates 0, taking the curvature of the reflective surface of the micro mirror 562 into consideration.

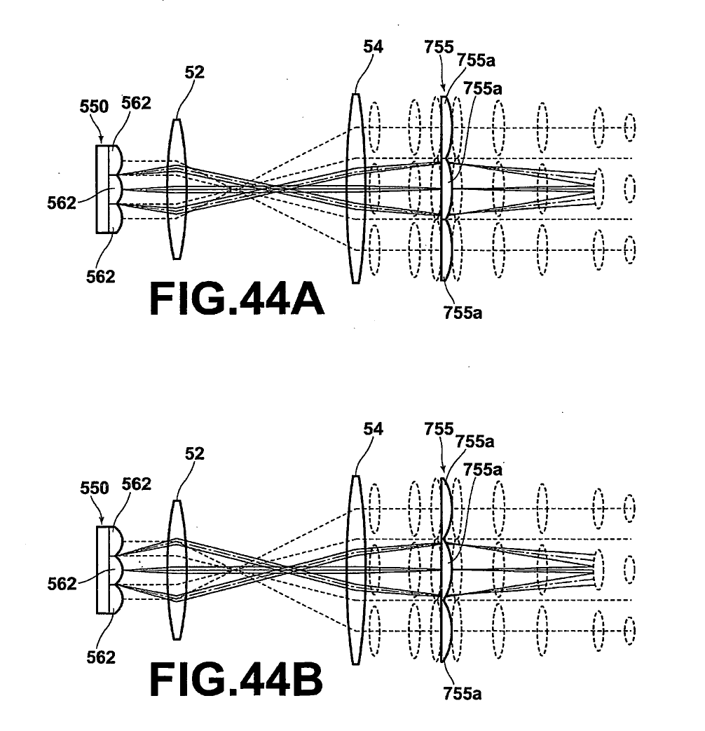

The manner in which aberrations caused by the distortion in the reflective surfaces of the micro mirrors 562 is corrected by the micro lenses 755a will be described with reference to FIG. 44A and FIG. 44B. FIGS. 44A and 44B are schematic diagrams that illustrate the manner in which the light reflected by the micro mirrors 562 are corrected within cross sections that pass through the optical axis and are parallel to the x direction and the y direction, respectively.

Note that the TIR prism 70 is omitted from FIGS. 44A and 44B. Three adjacent micro mirrors 562 are illustrated in FIGS. 44A and 44B, and the light beams reflected by the center and the edges of the central micro mirror 562 are denoted by solid lines. In addition, the manner in which the beam diameters of the beams reflected by the three micro mirrors 562 change as the beams propagate downstream from the lens system 54 is denoted by the ovals illustrated by broken lines.

In FIG. 44A and FIG. 44B, the positions upstream of the focusing position of the micro mirrors 562 are the separated condensing positions due to the convex shape thereof, as schematically illustrated by the separated ovals denoted by broken lines in FIG. 44A and FIG. 44B. The micro lens array 755 is provided at a separated condensing position.

As illustrated in FIG. 44A, the light, which is reflected by the micro mirror 562 having the convex shape, becomes divergent light, and enters the micro lens 755a after passing through the lens systems 52 and 54. As described previously, the power of the micro lens 655a in the x direction is positive. Therefore, the light that enters the micro lens 755a is condensed, and the beam diameter thereof becomes minimal at its beam waist position.

Meanwhile, as illustrated in FIG. 44B, the light, which is reflected by the micro mirror 562 having the convex shape with a smaller radius of curvature in the y direction, also becomes divergent light, and enters the micro lens 755a after passing through the lens systems 52 and 54. However, the angle formed by the light beam with respect to the optical axis is greater than that in the x direction. As described previously, the micro lens 755a has a positive power in the y direction, which is greater than the power in the x direction. Therefore, the light that enters the micro lens 755a is condensed more intensely in the y direction, and the beam diameter thereof becomes minimal at the same position as the aforementioned beam waist position of the x direction.

As described above, the micro lens 755a is configured to have powers of different magnitudes in the x direction and they direction. Thereby, astigmatic aberrations can be corrected, and the cross sectional shape of the beam can be prevented from becoming oval, even if the reflective surface of the micro mirror 562 has different negative powers in two directions within a plane perpendicular to the optical axis. Accordingly, the same advantageous effects as those of the previously described configuration can be obtained with this configuration.

Note that in the above description, the micro lenses 655a were described as cylindrical lenses having power only in the y direction. However, the present invention is not limited to this configuration. Lenses having powers other than 0 in both the x direction and the y direction may be used, wherein the power in the x direction is smaller than the power in the y direction. For example, a toric lens such as that illustrated in FIGS. 42A, 42B, 43A, and 43B may be employed. In addition, the shapes of the micro lenses in each direction are not limited to being spherical, and may be of aspherical shapes.

The micro lenses 655a and 755a of the micro lens arrays 655 and 755 of the ninth embodiment were described as refractive lenses. Alternatively, the gradient index lenses illustrated in FIGS. 23A, 23B, 24A, and 24B, the diffraction lens illustrated in FIGS. 26A and 26B, or combined lenses may be employed, to obtain the same advantageous effects as those obtained by the aforementioned micro lenses 655a and 755a.

Note that as described in the fifth embodiment with reference to FIG. 33 and FIG. 34, reductions in the light utilization efficiency and extinction ratio of the image exposure apparatus can prevented, in the case that another micro lens array is provided at the separated condensing position.

In addition, the aperture array 59 is provided in the separated condensing position in the ninth embodiment, in a manner similar to that of the fifth embodiment. The aperture array 59 is configured such that only light which has passed through the corresponding micro lens 655a or 755a enter each of the apertures 59a. Thereby, entry of light beams which have been condensed by adjacent micro lenses 655a and 755a that do not correspond to the apertures 59a, and entry of stray light beams can be prevented, thereby improving the extinction ratio of the image exposure apparatus. In addition, the aperture array 59 configured in this manner exhibits high light utilization efficiency, and may also function to shape the cross sectional shapes of the light beams with the apertures 59a.

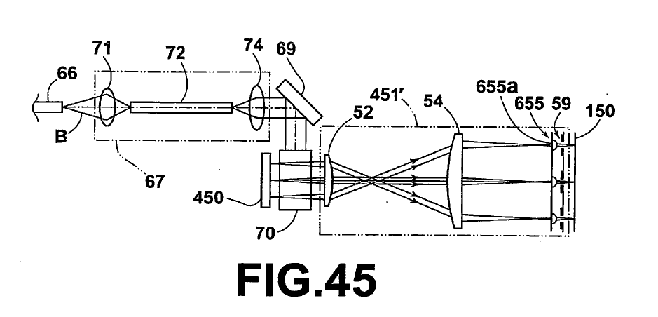

An image exposure apparatus according to a tenth embodiment of the present invention will be described next. FIG. 45 is a schematic sectional view that illustrates an exposure head of the image exposure apparatus according to the tenth embodiment of the present invention. The exposure head of FIG. 45 differs from the exposure head of the image exposure apparatus according to the ninth embodiment illustrated in FIG. 38 in that it comprises a focusing optical system 451′ instead of the focusing optical system 451. The focusing optical system 451′ differs from the focusing optical system 451 in that the second focusing optical system, comprising the lens systems 57 and 58, has been omitted. That is, in the tenth embodiment, light beams, which are condensed by the micro lens array 655, directly expose the photosensitive material 150. The tenth embodiment is capable of obtaining the same advantageous effects as the ninth embodiment.

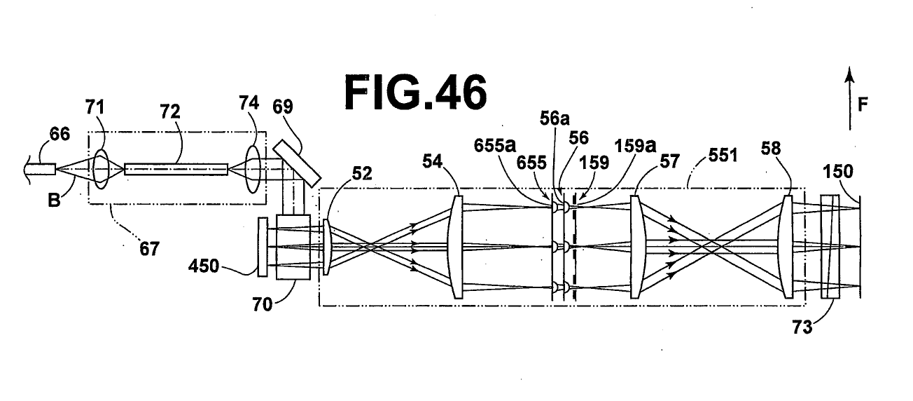

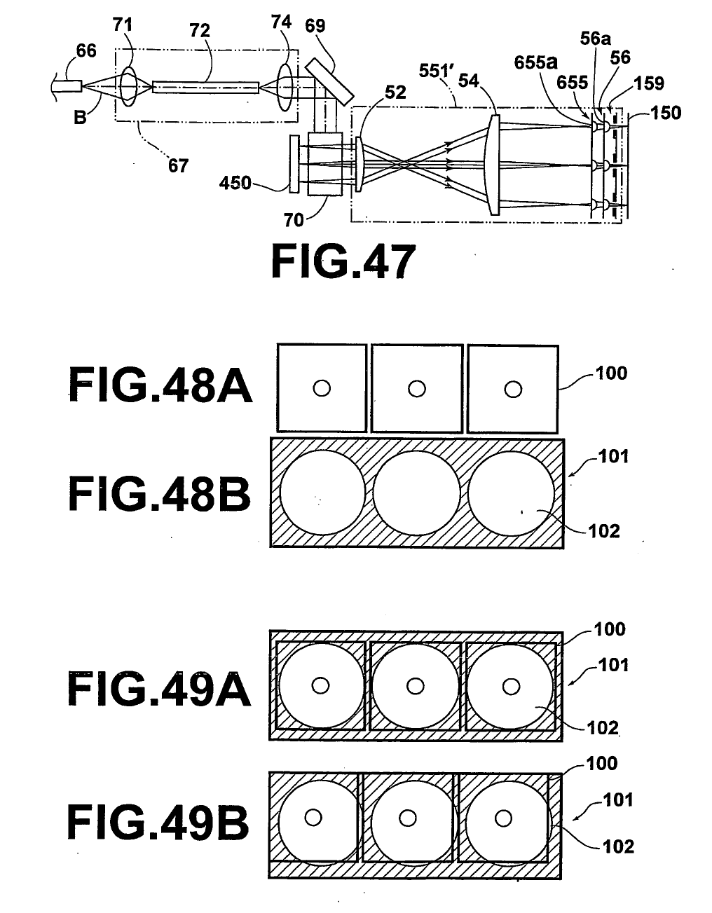

An image exposure apparatus according to an eleventh embodiment of the present invention will be described next. FIG. 46 is a schematic sectional view that illustrates an exposure head of the image exposure apparatus according to the eleventh embodiment of the present invention. The exposure head of FIG. 46 differs from the exposure head of the image exposure apparatus according to the ninth embodiment illustrated in FIG. 38 in that it further comprises a micro lens array 56 at a separated condensing position. The image exposure apparatus according to the eleventh embodiment employs a focusing optical system 551 instead of the focusing optical system 451 of the ninth embodiment. The focusing optical system 551 comprises: the first focusing optical system comprising lens systems 52 and 54; the second focusing optical system comprising the lens systems 57 and 58; the micro lens array 655; the condensing micro lens array 56; and an aperture array 159. The micro lens array 655, the condensing micro lens array 56, and the aperture array 159 are provided between the first and second focusing optical systems.

The condensing micro lens array 56 comprises a plurality of micro lenses 56a that individually condense the light beams from each pixel portion. Light beams, of which the aberration has been corrected by the micro lenses 655a of the micro lens array 655, enter the micro lenses 56a. In addition, the aperture array 159 has a great number of apertures 159a, corresponding to the micro lenses 56a of the micro lens array 56, formed in a light shielding member, similar to the aperture array 59. The aperture array 159 is provided such that only light beams that propagate through the corresponding micro lens 56a enter each aperture 159a.

The eleventh embodiment is capable of obtaining the same advantageous effects as the ninth embodiment. In addition, in the configuration described above, the light beams, which have been condensed and of which the cross sectional shapes have been shaped by the micro lens array 655, are further condensed by the micro lens array 56. Therefore, the beam spot size can be controlled to be even smaller than in the first embodiment, improving the sharpness of images to be exposed.

An image exposure apparatus according to a twelfth embodiment of the present invention will be described next. FIG. 46 is a schematic sectional view that illustrates an exposure head of the image exposure apparatus according to the twelfth embodiment of the present invention. The exposure head of FIG. 46 differs from the exposure head of the image exposure apparatus according to the eleventh embodiment illustrated in FIG. 45 in that it comprises a focusing optical system 551′ instead of the focusing optical system 551. The focusing optical system 551′ differs from the focusing optical system 551 in that the second focusing optical system, comprising the lens systems 57 and 58, has been omitted. That is, in the twelfth embodiment, light beams, which are condensed by the micro lens array 655 and the micro lens array 56, directly expose the photosensitive material 150. The twelfth embodiment is capable of obtaining the same advantageous effects as the eleventh embodiment.

Further, the condensing micro lens array 56 may be provided to be movable in the direction of the optical axes of the light beams. In this case, adjustments to the focal point of the light beams are facilitated. Particularly, because the condensing micro lens array 56 is provided at the separated condensing position and not at the focusing position, the variance in light utilization efficiency can be suppressed to a minimum when the focal point is adjusted. That is, the variance in light utilization efficiency at the separated condensing position and the vicinity thereof is smaller than that at the focusing position and the vicinity thereof. Therefore, drastic changes in the light utilization efficiency when the condensing micro lens array 56 is moved in the direction of the optical axes can be prevented.

Note that the diagonals of the micro mirrors were designated as the x direction and the y direction in the first through twelfth embodiments described above, and the micro lenses were configured to have different powers along these directions. However, it is desirable for the designation of the x and y directions to be determined according to the distribution of distortion of the micro mirrors. For example, in the case that conspicuously different curved surfaces are present along the directions of the edges of the micro mirror, it is desirable for the micro lenses to have different powers along the directions of the edges.

In addition, the laser light source was employed as the light source for irradiating the spatial light modulating element in the first through twelfth embodiments described above. However, the present invention is not limited to this configuration, and other light sources, such as a mercury halide lamp, may alternatively be employed.

Further, the DMD's were employed as the spatial light modulating element in the first through twelfth embodiments described above. However, the same advantageous effects can be obtained by applying the structures of the present invention to image exposure apparatuses that employ reflective spatial light modulating elements other than DMD's.

1-11. (canceled)

12. An image exposure apparatus, comprising:
a spatial light modulating element, in which a plurality of pixel portions for individually modulating light irradiated thereon according to control signals are provided;
a light source, for irradiating light onto the spatial light modulating element; and
a focusing optical system for focusing an image borne by light modulated by each pixel portion of the spatial light modulating element onto a photosensitive material, including: an optical system for focusing light beams which have been modulated by each of the pixel portions of the spatial light modulating element, to focus the image of each pixel portion; and a micro lens array, in which a plurality of micro lenses into which the light beams modulated by the pixel portions and passed through the optical system enter individually are provided;
the micro lens array being provided in the vicinity of the position at which the images of the pixel portions are focused by the optical system; and
each micro lens of the micro lens array having different powers in two directions within a plane perpendicular to the optical axis of the light beam that enters thereinto, in order to correct aberrations due to isotropic distortions of the pixel portions.

13. An image exposure apparatus as defined in claim 12, wherein:
the micro lenses are refractive lenses.

14. An image exposure apparatus as defined in claim 12, wherein:
the micro lenses are gradient index lenses.

15. An image exposure apparatus as defined in claim 12, wherein:
the micro lenses are diffraction lenses.

16. An image exposure apparatus as defined in claim 12, wherein:
the micro lenses are structured by combining at least two of: refractive lenses; gradient index lenses; and diffraction lenses.

17. An image exposure apparatus as defined in claim 12, further comprising:
a condensing micro lens array, in which a plurality of micro lenses for individually condensing the light beams which have propagated thereto via each of the pixel portions are provided, is provided at a separated condensing position of the pixel portions, the optical system, and the micro lens array, which is offset from a position at which the images of the pixel portions are focused by the optical system.

18. An image exposure apparatus, comprising:
a spatial light modulating element, in which a plurality of pixel portions for individually modulating light irradiated thereon according to control signals are provided;
a light source, for irradiating light onto the spatial light modulating element; and
a focusing optical system for focusing an image borne by light modulated by each pixel portion of the spatial light modulating element onto a photosensitive material, including: an optical system for focusing light beams which have been modulated by each of the pixel portions of the spatial light modulating element, to focus the image of each pixel portion; and a micro lens array, in which a plurality of micro lenses into which the light beams modulated by the pixel portions and passed through the optical system enter individually are provided;
the pixel portions having powers of different signs in two directions within a plane perpendicular to the optical axis of the light beam;
the micro lens array being provided at a separated condensing position, which is offset from a position at which the images of the pixel portions are focused by the optical system; and
each micro lens of the micro lens array having different powers in two directions within a plane perpendicular to the optical axis of the light beam that enters thereinto, in order to correct aberrations due to the powers of different signs of the pixel portions.

19. An image exposure apparatus as defined in claim 18, wherein:
the micro lenses are refractive lenses.

20. An image exposure apparatus as defined in claim 18, wherein:
the micro lenses are gradient index lenses.

21. An image exposure apparatus as defined in claim 18, wherein:
the micro lenses are diffraction lenses.

22. An image exposure apparatus as defined in claim 18, wherein:
the micro lenses are structured by combining at least two of: refractive lenses; gradient index lenses; and diffraction lenses.

23. An image exposure apparatus as defined in claim 18, further comprising:
a condensing micro lens array, in which a plurality of micro lenses for individually condensing the light beams which have propagated thereto via each of the pixel portions are provided, is provided at a separated condensing position of the pixel portions, the optical system, and the micro lens array, which is offset from a position at which the images of the pixel portions are focused by the optical system.

24. An image exposure apparatus, comprising:
a spatial light modulating element, in which a plurality of pixel portions for individually modulating light irradiated thereon according to control signals are provided;
a light source, for irradiating light onto the spatial light modulating element; and
a focusing optical system for focusing an image borne by light modulated by each pixel portion of the spatial light modulating element onto a photosensitive material, including: an optical system for focusing light beams which have been modulated by each of the pixel portions of the spatial light modulating element, to focus the image of each pixel portion; and a micro lens array, in which a plurality of micro lenses into which the light beams modulated by the pixel portions and passed through the optical system enter individually are provided;
the pixel portions having powers of the same sign and different magnitudes in two directions within a plane perpendicular to the optical axis of the light beam;
the micro lens array being provided at a separated condensing position, which is offset from a position at which the images of the pixel portions are focused by the optical system; and
each micro lens of the micro lens array having different powers in two directions within a plane perpendicular to the optical axis of the light beam that enters thereinto, in order to correct aberrations due to the powers of different magnitudes of the pixel portions.

25. An image exposure apparatus as defined in claim 24, wherein:
the micro lenses are refractive lenses.

26. An image exposure apparatus as defined in claim 24, wherein:
the micro lenses are gradient index lenses.

27. An image exposure apparatus as defined in claim 24, wherein:
the micro lenses are diffraction lenses.

28. An image exposure apparatus as defined in claim 24, wherein:
the micro lenses are structured by combining at least two of: refractive lenses; gradient index lenses; and diffraction lenses.

29. An image exposure apparatus as defined in claim 24, further comprising:
a condensing micro lens array, in which a plurality of micro lenses for individually condensing the light beams which have propagated thereto via each of the pixel portions are provided, is provided at a separated condensing position of the pixel portions, the optical system, and the micro lens array, which is offset from a position at which the images of the pixel portions are focused by the optical system.
